(19) United States
(12) Patent Application Publication
(10) Pub. No.: US 2026/0054987 A1
(43) Pub. Date: Feb. 26, 2026

(54) METHOD OF SYNTHESIZING COVALENTLY BONDED LATTICES

(71) Applicant: CASE WESTERN RESERVE UNIVERSITY, Cleveland, OH (US)

(72) Inventors: Valentin Rodionov, Cleveland, OH (US); Victor Desyatkin, Cleveland, OH (US); William Blake Martin, Cleveland, OH (US)

(21) Appl. No.: 19/103,277

(22) PCT Filed: Aug. 8, 2023
(86) PCT No.: PCT/US2023/029690

§ 371 Date: Feb. 12, 2025

Related U.S. Application Data
(60) Provisional application No. 63/397,416, filed on Aug. 12, 2022.

(51) Int. Cl. C01B 32/15

(52) U.S. Cl. CPC C01B 32/15; C01P 2002/20; C01P 2002/60; C01P 2002/82; C01P 2002/85; C01P 2002/86; C01P 2004/03; C01P 2004/04

(57) ABSTRACT

A method for the synthesis of multilayer γ-graphyne, an intrinsically semi-conducting sp²/sp¹ allotrope of carbon, through crystallization-assisted irreversible cross-coupling polymerization.

### RELATED APPLICATION

This application claims priority from U.S. Provisional Application No. 63/397,416, filed Aug. 12, 2022, the subject matter of which is incorporated herein by reference in its entirety.

### GOVERNMENT FUNDING

This invention was made with government support under DE-SC0022100 awarded by the Department of Energy. The government has certain rights in the invention.

### BACKGROUND

γ-Graphyne is the most symmetric sp²/sp¹ allotrope of carbon, which can be viewed as graphene uniformly expanded through insertion of two-carbon acetylenic units. To date, bulk γ-graphyne has remained synthetically elusive. Single-layer γ-graphyne is predicted to be a semiconductor with a moderate band gap, ultrafast charge carrier mobility comparable to that of graphene, high thermal conductivity, and exceptional strength. Because of these properties γ-graphyne could form the basis for the next generation of carbon-based electronics, photonics, and solar cells. Graphyne-based devices could be ultra-thin, flexible, and operate at speeds unattainable by silicon chips. γ-Graphyne oligomers containing up to four dehydrobenzo[12]annulene (12-DBA) repeat units have been prepared through multistep organic synthesis, but the extended crystalline lattice has remained out of reach until now.

Pyrolytic and vapor-deposition methodologies commonly used for the controlled synthesis of benzenoid allotropes of carbon are unsuitable for sp¹-containing structures, as acetylenes readily convert to graphene or amorphous carbon at elevated temperatures. While graphdiyne and graphdiyne-graphene heterostructures have been synthesized via templated solution-phase 2D polymerizations, a similar approach has not been previously attempted for 7-graphyne. Reported graphdiyne syntheses rely on polymerization of highly energetic hexaethynylbenzene through Glaser-Hay sp¹-sp¹ coupling, which can be conveniently localized at metal surfaces. A comparable synthesis of γ-graphyne would require either coupling between sp¹ and sp² carbons, or de novo formation of three acetylenic bonds per each 12-DBA repeat unit. The most common and general methodology for sp¹-sp² C—C coupling is the Sonogashira reaction. The mechanism of this reaction is thought to involve a homogeneous Pd⁰ catalytic cycle, like all other Pd-catalyzed cross-couplings. Therefore, attempting to confine this chemistry to the surface of a template would be challenging. Moreover, previously reported γ-graphyne oligomers are distorted from planarity, due to steric hindrance introduced by the terminal functionalities. This inevitable distortion, as well as the typically poor solubility of oligomers, limits stepwise extension of the lattice beyond 3-4 12-DBA units.

Hu et al. in the “Synthesis Of γ-Graphyne Using Dynamic Covalent Chemistry.” Nat. Synth 1, 449-454 (2022) claim a synthesis of γ-graphyne in bulk through reversible alkyne methathesis. However, this method is not scalable as the key precursors, 1,2,3,4,5,6-hexakis[2-(4-hexylphenyl)ethynyl]benzene (HHEB) and 1,2,3,4,5,6-hexapropynylbenzene (HPB), are both unstable and extremely difficult to synthesize. These compounds are closely related to hexaethynylbenzene, which is infamous for being explosive on contact, and is never isolated or handled in pure form for that reason. γ-Graphyne described by Hu et al. always features n-hexyl edge groups, which is undesirable for further edge elaboration or use of this material in devices. Moreover, the Hu manuscript indicates that only a reversible reaction could be used to make this class of materials. The presence of a catalyst at the later stages of such a reversible reaction is likely to introduce undesirable defects in the material, including but not limited to inter-sheet crosslinks.

### SUMMARY

Embodiments described herein relate to a method of synthesizing covalently bonded lattices based on irreversible bond-making reactions which favor exhaustive substitution on multi-functional substrates and particularly relate to a method of preparing or synthesizing multilayer γ-graphyne, an sp²/sp¹ allotrope of carbon, through crystallization-assisted irreversible cross-coupling polymerization. We found that under appropriately adjusted Sonogashira coupling conditions, a multifunctional 1,3,5-trihalo-2,4,6-triethynylbenzene monomer can be polymerized into extended γ-graphyne. The main idea that guided our thinking is that an effective route to graphynes and similar rigid 2D polymers could proceed through reactions that create multiple bonds in a single step or through a series of kinetically coupled fast steps. Such mechanism would bypass the kinetic dead-end of partially connected intermediates, which limited all the previously described syntheses. Furthermore, this type of multi-site polymerization would be self-correcting. Defects in the growing lattice would be the most reactive sites due to local distortions and strain, which could be relieved upon multi-site reaction with the monomer.

In some embodiments, the bond-making reaction favoring exhaustive reactivity on multifunctional substrates is a Sonogashira cross-coupling reaction between a terminal alkyne and an aryl halide.

In some embodiments, a reactant for synthesizing the covalently bonded lattice can be any of the possible 1,3,5-trihalo-2,4,6-triethynylbenzenes, either symmetric or unsymmetric, where the halogen is any of Cl, Br, or I.

In other embodiments, the reactant for synthesizing the covalently bonded lattice can be any of the possible ((2,4,6-trihalobenzene-1,3,5-triyl)tris(ethyne-2,1-diyl))tris(trimethylsilanes), either symmetric or unsymmetric, where the halogen is any of Cl, Br, or I.

The Sonogashira cross-coupling reaction is performed using a palladium catalyst. The palladium source can be selected from palladium black, palladium on carbon, palladium(π-cinnamyl) chloride dimer, bis(triphenylphosphine)palladium(II) dichloride, bis(benzonitrile)palladium(II) chloride, bis(triphenylphosphine)palladium(II) diacetate, tetrakis(triphenylphosphine)palladium(0), bis(dibenzylideneacetone)palladium(0), tris(dibenzylideneacetone)dipalladium(0), dichlorobis(tricyclohexylphosphine)palladium(II), dichlorobis(tri-o-tolylphosphine)palladium(II), allylpalladium(II) chloride dimer, (2-methylallyl)palladium(II) chloride dimer, (1,3-bis(2,6-diisopropylphenyl)imidazolidene) (3-chloropyridyl) palladium(II) dichloride, (1,3-bis(2,6-dimethylphenyl)imidazolidene) (3-chloropyridyl) palladium(II) dichloride, [1,3-bis(2,6-diisopropylphenyl)imidazol-2-ylidene](3-chloropyridyl)palladium(II) dichloride, palladium(II) 2,4-pentanedionate, or any of the possible alkali metal salts of tris(3,3′,3″-phosphinidynetris(benzenesulfonato)palladium(0).

The Sonogashira cross-coupling reaction can also be performed with a copper co-catalyst. The copper co-catalyst can be selected from copper(I) iodide, copper(I) chloride, copper(I) bromide, tetrakis(acetonitrile)copper(I) hexafluorophosphate, tetrakisacetonitrile copper(I) triflate, copper(0) foil or shavings combined with pyridine, copper(0) foil or shavings combined with any aliphatic tertiary amine, or copper(II) sulfate combined with sodium ascorbate.

In some embodiments, the reactant, palladium catalyst and copper co-catalyst are provided in a solvent. The solvent can be selected from pyridine, tetrahydrofuran, mixtures of tetrahydrofuran and N,N-diisopropylethylamine, toluene, benzene, water, mixtures thereof, or biphasic mixtures of water and an immiscible organic solvent.

In some embodiments, loading of the Pd catalyst can be between 0.5 mol % and 120 mol % relative to the reactant, e.g., 1,3,5-trihalo-2,4,6-triethynylbenzene.

In other embodiments, loading of the Cu co-catalyst can be between 0.1 mol % and 10 mol % relative to the reactant, e.g., 1,3,5-trihalo-2,4,6-triethynylbenzene.

In some embodiments, the reaction is performed at a reaction temperature of about 60° C. to about 130° C.

In some embodiments, the reaction is performed in the presence of a soluble fluoride salt.

In some embodiments, ordered two-dimensional polymerization occurs in the absence of a substrate or added template.

In some embodiments, the synthesis yields multilayer γ-graphyne with linear size of crystalline domains in the range of 10 nanometers to 500 micrometers.

In other embodiments, the synthesis yields few-layer (e.g., 1-25 layers) γ-graphyne with linear size of crystalline flakes in the range of 10 nanometers to 500 micrometers.

### BRIEF DESCRIPTION OF THE DRAWINGS

FIGS. 1(A-E) illustrate allotropes of carbon. (A) Graphite, graphene, zigzag nanotube and buckminsterfullerene C60. (B) Biphenylene network. (C) x,y,z-Graphynes. 12,12,12-graphyne and 6,6,12-graphyne. (D) Graphynes-n (graphdiyne for n=2). (E) Graphyne (or γ-graphyne).

FIGS. 2(A-G) illustrates two-dimensional polymerizations of TBETB. (A) Overview of selected reaction conditions. (B-D) Representative bright-field TEM, SAED, and SEM of the carbon flakes obtained from Pd(PPh₃)₄/Cu foil reaction. (E-G) Representative bright-field TEM, SAED, and SEM of the carbon flakes obtained via the Pd(PPh₃)₄/CuI protocol.

FIGS. 3(A-D) illustrate high resolution XPS data for C1s peak regions. (A) Carbon flakes obtained through Pd(PPh₃)₄/CuI protocol. (B) Carbon flakes obtained through Pd(PPh₃)₄/Cu foil protocol. (C) Control experiment with only Pd(PPh₃)₄. (D) Control experiment with no catalysts.

FIG. 4 illustrates ¹³C NMR spectrum of 1,3,5-tribromo-2,4,6-triiodobenzene in DMSO-d6.

FIG. 5 illustrates ¹H NMR spectrum of ((2,4,6-tribromobenzene-1,3,5-triyl)tris(ethyne-2,1-diyl))tris-(trimethylsilane) in CDCl₃.

FIG. 6 illustrates ¹³C NMR spectrum of ((2,4,6-tribromobenzene-1,3,5-triyl)tris(ethyne-2,1-diyl))tri (trimethylsilane) in CDCl₃.

FIG. 7 illustrates ¹H NMR spectrum of 1,3,5-tribromo-2,4,6-triethynylbenzene, TBTEB in DMSO-d6.

FIG. 8 illustrates ¹³C NMR spectrum of 1,3,5-tribromo-2,4,6-triethynylbenzene, TBTEB in DMSO-d6.

FIG. 9 illustrates FTIR of 1,3,5-tribromo-2,4,6-triiodobenzene (ATR-FTIR on diamond).

FIG. 10 illustrates FTIR of ((2,4,6-tribromobenzene-1,3,5-triyl)tris(ethyne-2,1-diyl))tris(trimethylsilane) (ATR-FTIR on germanium).

FIG. 11 illustrates FTIR of 1,3,5-tribromo-2,4,6-triethynylbenzene, TBTEB (ATR-FTIR on germanium).

FIG. 12 illustrates XPS survey corresponding to Table 1, Entry 1 (TBTEB and Pd(PPh₃)₄/CuI in pyridine).

FIG. 13 illustrates XPS survey corresponding to Table 1, Entry 2 (TBTEB and Pd(PPh₃)₄/Cu foil in pyridine).

FIG. 14 illustrates XPS survey corresponding to Table 1, Entry 3 (TBTEB and Pd(PPh₃)₄ in pyridine, no Cu).

FIG. 15 illustrates XPS survey corresponding to Table 1, Entry 4 (thermal decomposition of TBTEB in refluxing pyridine).

FIG. 16(A-D) illustrate High resolution XPS data for Cis peak regions. (A) Table 1, Entry 1 (TBTEB and Pd(PPh₃)₄/CuI in pyridine). (B) Table 1, Entry 2 (TBTEB and Pd(PPh₃)₄/Cu foil in pyridine). (C) Table 1, Entry 3 (control experiment with TBTEB and Pd(PPh₃)₄ in pyridine, no Cu). (D) Table 1, Entry 4 (control experiment with no catalysts).

FIGS. 17(A-D) illustrate high resolution Br 3d region XPS spectra of selected carbon material samples. (A) Table 1, Entry 1 (TBTEB and Pd(PPh₃)₄/CuI in pyridine). (B) Table 1, Entry 2 (TBTEB and Pd(PPh₃)₄/Cu foil in pyridine). (C) Table 1, Entry 3 (control experiment with TBTEB and Pd(PPh₃)₄ in pyridine, no Cu). (D) Table 1, Entry 4 (control experiment with no catalysts).

FIGS. 18(A-B) illustrate: (A) photo of the carbon material corresponding to Table 1, Entry 1 (TBTEB and Pd(PPh₃)₄/CuI in pyridine). (B) Photo of the carbon material corresponding to Table 1, Entry 2 (TBTEB and Pd(PPh₃)₄/Cu foil in pyridine).

FIG. 19(A-D) illustrate representative bright field TEM images of the carbon product corresponding to Table 1, Entry 1 (TBTEB and Pd(PPh₃)₄/CuI in pyridine).

FIGS. 20(A-F) illustrates representative bright field TEM images of the carbon product corresponding to Table 1, Entry 2 (TBTEB and Pd(PPh₃)₄/Cu foil in pyridine). (E-F) Representative SAED ring patterns for the same material.

FIGS. 21(A-C) illustrate Representative bright field TEM images of the carbon product corresponding to Table 1, Entry 3 (control experiment with TBTEB and Pd(PPh₃)₄ in pyridine, no Cu).

FIG. 22(A-C) illustrate representative bright field TEM images of the carbon product corresponding to Table 1, Entry 4 (thermal decomposition of TBTEB in refluxing pyridine).

FIGS. 23(A-B) illustrate representative SEM images of the carbon product corresponding to Table 1, Entry 2 (TBTEB and Pd(PPh₃)/Cu foil in pyridine).

FIGS. 24(A-H) illustrate possible stacking modes of γ-graphyne sheets and their simulated SAED patterns in the c orientation (sheets perpendicular to the incident beam). Interatomic distances are obtained from DFT calculations.

FIGS. 25(A-H) illustrate possible stacking modes of γ-graphyne sheets and their simulated SAED patterns for 45° rotation from the (0001) pole to a viewing direction (matching the experimental diffraction pattern rotated 45°). Interatomic distances are obtained from DFT calculations.

FIGS. 26(A-H) illustrate possible stacking modes of γ-graphyne sheets and their simulated SAED patterns in the b orientation (sheets parallel to the incident beam). Interatomic distances are obtained from DFT calculations.

FIG. 27 illustrates DFT-generated potential energy surfaces for binding of TBTEB monomer to a γ-graphyne monolayer.

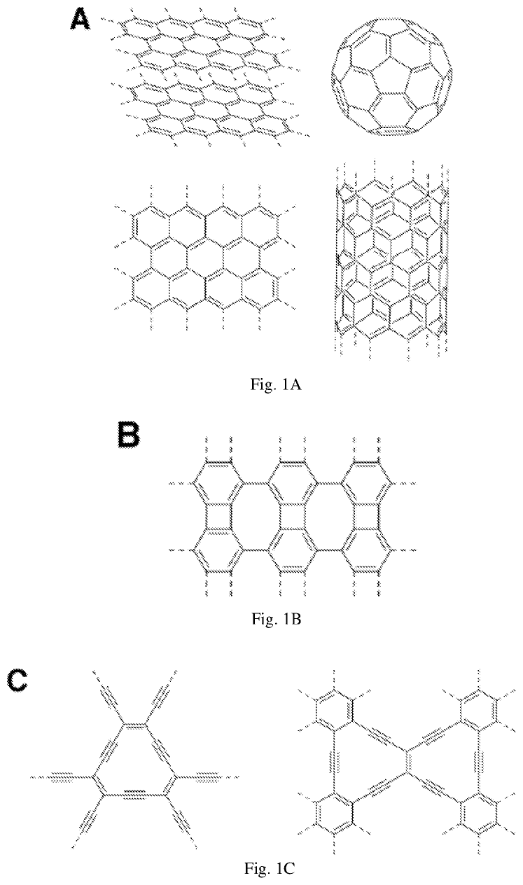

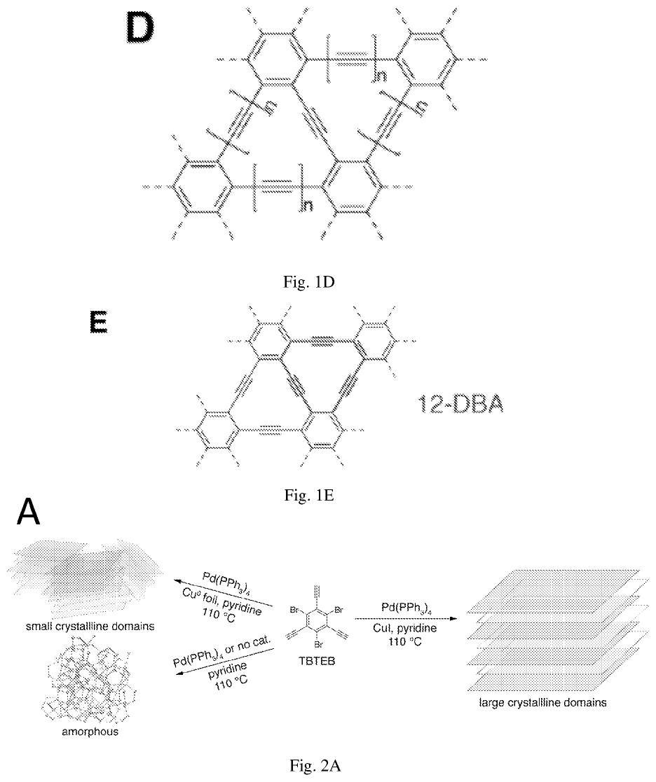

### DETAILED DESCRIPTION

All scientific and technical terms used in this application have meanings commonly used in the art unless otherwise specified. The definitions provided herein are to facilitate understanding of certain terms used frequently herein and are not meant to limit the scope of the application.

The articles “a” and “an” are used herein to refer to one or to more than one (i.e., to at least one) of the grammatical object of the article. By way of example, “an element” means one element or more than one element.

The term “about” will be understood by persons of ordinary skill in the art and will vary to some extent on the context in which it is used.

When a certain part “comprises” a certain component, unless otherwise disclosed to the contrary, it is meant that the part may further comprise another component without excluding another component.

The term “combinations thereof” included in the expression of the Markush form means one or more mixtures or combinations selected from the group consisting of components described in the expression of the Markush form, and means to include at least one selected from the group consisting of the components.

The term “A and/or B” means “A or B, or A and B”.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 3, 4, 5, 5.5 and 6. This applies regardless of the breadth of the range.

Embodiments described herein relate to a method of synthesizing covalently bonded lattices based on irreversible bond-making reactions which favor exhaustive substitution on multi-functional substrates and particularly relate to a method of preparing or synthesizing multilayer γ-graphyne, an sp²/sp¹ allotrope of carbon, through crystallization-assisted irreversible cross-coupling polymerization. We found that under appropriately adjusted Sonogashira coupling conditions, a multifunctional 1,3,5-trihalo-2,4,6-triethynylbenzene monomer can be polymerized into extended γ-graphyne. The main idea that guided our thinking is that an effective route to graphynes and similar rigid 2D polymers could proceed through reactions that create multiple bonds in a single step or through a series of kinetically coupled fast steps. Such mechanism would bypass the kinetic dead-end of partially connected intermediates, which limited all the previously described syntheses. Furthermore, this type of multi-site polymerization would be self-correcting. Defects in the growing lattice would be the most reactive sites due to local distortions and strain, which could be relieved upon multi-site reaction with the monomer.

In some embodiments, the bond-making reaction is a Sonogashira cross-coupling reaction between a terminal alkyne and an aryl halide. Each of the terminal alkyne groups is capable of cross-coupling via the Sonogashira cross-coupling coupling reaction with a halogen group of the aryl halide, thereby forming a network of such reactants linked by the acetylene groups. The v-graphyne can consist of triple bond (sp) and double bond (sp2) carbon atoms arranged in a crystal lattice of benzene rings connected by acetylene bonds and having a planar structure with an atomic thickness.

In some embodiments, the reactant for synthesizing the covalently bonded lattice can be any of the possible 1,3,5-trihalo-2,4,6-triethynylbenzene, either symmetric or unsymmetric, where the halogen is any of Cl, Br, or I. For example, a trihalotriethynylbenzene can be 1,3,5-tribromo-2,4,6-triethynylbenzene or 1,3,5-tribromo-2,4,6-triethynylbenzene.

In other embodiments, the reactant for synthesizing the covalently bonded lattice can be any of the possible ((trihalobenzenetriyl)tris(ethynediyl))tris(trimethylsilanes), either symmetric or unsymmetric, where the halogen is any of Cl, Br, or I. For example, a ((trihalobenzenetriyl)tris(ethynediyl))tris(trimethylsilane) can be ((2,4,6-tribromobenzene-1,3,5-triyl)tris(ethyne-2,1-diyl))tris(trimethylsilane).

In some embodiments, the catalyst can be a compound of palladium. The palladium source can be selected from palladium black, palladium on carbon, palladium(π-cinnamyl) chloride dimer, bis(triphenylphosphine)palladium(II) dichloride, bis(benzonitrile)palladium(II) chloride, bis(triphenylphosphine)palladium(II) diacetate, tetrakis(triphenylphosphine)palladium(0), bis(dibenzylideneacetone)palladium(0), tris(dibenzylideneacetone)dipalladium(0), dichlorobis(tricyclohexylphosphine)palladium(II), dichlorobis(tri-o-tolylphosphine)palladium(II), allylpalladium(II) chloride dimer, (2-methylallyl)palladium(II) chloride dimer, (1,3-bis(2,6-diisopropylphenyl)imidazolidene) (3-chloropyridyl) palladium(II) dichloride, (1,3-bis(2,6-dimethylphenyl)imidazolidene) (3-chloropyridyl) palladium(II) dichloride, [1,3-bis(2,6-diisopropylphenyl)imidazol-2-ylidene](3-chloropyridyl)palladium(II) dichloride, palladium(II) 2,4-pentanedionate, or any of the possible alkali metal salts of tris(3,3′,3″-phosphinidynetris(benzenesulfonato)palladium(0).

In other embodiments, the catalyst can include a copper co-catalyst. The copper co-catalyst can be selected from copper(I) iodide, copper(I) chloride, copper(I) bromide, tetrakis(acetonitrile)copper(I) hexafluorophosphate, tetrakisacetonitrile copper(I) triflate, copper(0) foil or shavings combined with pyridine, copper(0) foil or shavings combined with any aliphatic tertiary amine, or copper(II) sulfate combined with sodium ascorbate.

In some embodiments, the reactant, palladium catalyst and copper co-catalyst are provided in a solvent. The solvent can be selected from pyridine, tetrahydrofuran, mixtures of tetrahydrofuran and N,N-diisopropylethylamine, toluene, benzene, water, combinations thereof, or biphasic mixtures of water and an immiscible organic solvent.

In one example, the Sonogashira cross-coupling reaction may be performed in a solution or mixture containing the reactant, a palladium catalyst and a copper co-catalyst. In some embodiments, the palladium catalyst is Pd(PPh₃)₄ and the copper co-catalyst is CuI. Such solution may be prepared by dissolving solid Pd(PPh₃)₄ and CuI in a solvent mixture. The solvent mixture may include an amine base and organic solvent. For example, the amine base can include pyridine or triethylamine and the organic solvent can include toluene.

In some embodiments, the reaction can also be performed in the presence of a soluble fluoride salt.

In some embodiments, loading of the Pd catalyst in the reaction mixture can be between about 0.5 mol % and about 120 mol % relative to the reactant, e.g., 1,3,5-trihalo-2,4,6-triethynylbenzene. For example, the Pd catalyst can be about 25 mol % to about 115 mol %, about 50 mol % to about 110 mol %, or about 75 mol % to about 105 mol % (e.g., about 100 mol %) relative to the reactant.

In other embodiments, loading of the Cu co-catalyst in the reaction mixture can be between about 0.1 mol % and about 10 mol % relative to the reactant, e.g., 1,3,5-trihalo-2,4,6-triethynylbenzene. For example, the Cu co-catalyst can be about 1 mol % to about 8 mol %, about 2 mol % to about 7 mol %, or about 3 mol % to about 6 mol % (e.g., about 4 mol %) relative to the reactant.

In some embodiments, a reaction solution or mixture including the reactant, palladium catalyst, copper co-catalyst, solvent, and optional soluble fluoride salt can be heated to a temperature and for a duration of time effective to produce the covalently bonded lattices and/or multilayer γ-graphyne. In some embodiments, the reaction is performed in an evacuated inert atmosphere at a reaction temperature of about 60° C. to about 130° C. and the duration time can be at least about 1 hour, at least about 12 hours, at least about 24 hours, at least about 48 hours, or at least about 72 hours (e.g., 72 hours).

In some embodiments, ordered two-dimensional polymerization occurs in the absence of a physical substrate or added template that includes a surface on which two-dimensional polymerization could potentially occur. Such a physical substrate could potentially include a metal foil, fiber, or particle that defines a surface on which polymerization could occur.

The as synthesized covalently bonded lattices and/or multilayer γ-graphyne can be isolated and/or removed from the reaction solution and rinsed with solvent, such as ethanol, for several times (e.g., 5 times) to remove any residuals left on the surface of the synthesized covalently bonded lattices and/or multilayer γ-graphyne material.

In some embodiments, the synthesized graphyne can have substantially perfect crystal uniformity and/or substantially perfect hexagonal crystal symmetry with minimal to no defects. The graphyne can also have a 1:1 ratio of sp¹ to sp² carbons in the crystalline material.

In some embodiments, the synthesis yields multilayer γ-graphyne with linear size of crystalline domains in the range of about 10 nanometers to about 500 micrometers. For example, the linear size of crystalline domains can be about 10 nanometers to about 500 micrometers, about 50 nanometers to about 100 micrometers, about 100 nanometers to about 50 micrometers, or about 500 nanometers to about 10 micrometers.

In other embodiments, the synthesis yields few-layer (e.g., 1-25 layers) γ-graphyne with linear size of crystalline flakes in the range of 10 nanometers to 500 micrometers.

Still other embodiments relate to γ-graphyne with a linear size of crystalline domains in the range of 10 nanometers to 500 micrometers.

In some embodiments, the γ-graphyne can include multifunctional reactive groups on edges of the γ-graphyne. The multifunctional reactive groups can be selected from alkyne and halo groups.

Other embodiments described herein relate to graphyne prepared by the process described herein.

The γ-graphyne material may be used in various applications including applications in energy, environment, and biomedicine. For instance, the γ-graphyne material can be used in applications of adsorption, capture and separation of carbon dioxide, carbon monoxide, ammonia, sulfur dioxide and other gases, the application of adsorption of polymer chain and acrolein and other organic matters, the application of selective filtration and purification of water, and the application of seawater separation and desalination, as the monoatomic catalytic substrate of noble metals and the application of stable noble metal catalysis, and the detection of toxic and harmful substances, such as hydrogen peroxide, carbon monoxide, and toxic gases. Biomedical aspects include the application of amino acid detection, the application of calmodulin structure and performance regulation, and the application of promoting the extraction of cholesterol from protein. Energy applications can include electrochemical energy storage, hydrogen storage, high-density magnetic storage, as a thermoelectric, manufacturing of electronic and/or photonic devices (e.g., nonlinear optics), rechargeable batteries, or organic solar cells. Still other applications can include use in extreme-strength composites and as catalysis. Moreover, the γ-graphyne material can be used in solar cells, lithium batteries, photocatalysis, oxygen reduction, field emission performance, and real-time detection of DNA.

For example, owing to its regular porous structure and unique electronic properties, the nano-sized pore of γ-graphyne can be used to accommodate ions for energy storage, while the highly π-conjugated electron rich framework can provide d-π interaction with transition metals to prepare single-atom catalysts.

Hydrogen storage is another potential application of γ-graphyne material. The Kubas interaction, which refers to the hybridization of d orbitals and σ/σ* orbitals in H₂ molecules is known to enhance the binding energy of H₂. Calcium ions can also result in Kubas interactions with H₂ molecules. It was previously found that γ-graphyne can be used as a support material to disperse Ca ions effectively inhibiting aggregation or clustering of these of these ions, which is essential for maintaining H₂ storage capacity. Lu, Na, and Ti atoms are also supported on γ-graphyne and can provide enhanced hydrogen storage capabilities.

Strong d-π interactions between γ-graphyne and metal atoms can allow γ-graphyne to be used in γ-graphyne supported transition/noble metal (NM) single-atom catalysts. The binding energies of noble metal single atoms on γ-graphyne are considerably larger than those on graphene because the p/p* orbitals of the triple bonds can directly point toward metal atoms. γ-graphyne supported Fe single-atom catalyst exhibits a high catalytic activity for CO oxidation, which proceeds via the Eley-Rideal mechanism with a low energy barrier. In acidic medium, γ-graphyne supported Fe and Co single-atom catalysts can catalyze the oxygen reduction reaction through an efficient four-electron reduction mechanism. γ-graphyne supported Cu single-atom catalyst exhibits catalytic efficiency for CO₂ electroreduction and hydrogen evolution reactions. Similarly, Ru-decorated γ-graphyne can efficiently catalyze the CO reduction reaction via the Langmuir-Hinshelwood path.

The following example is for the purpose of illustration only and are not intended to limit the scope of the claims, which are appended hereto.

### Example

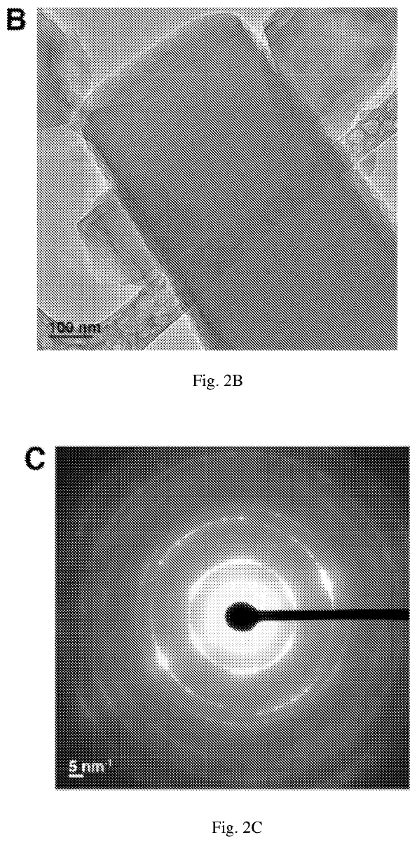

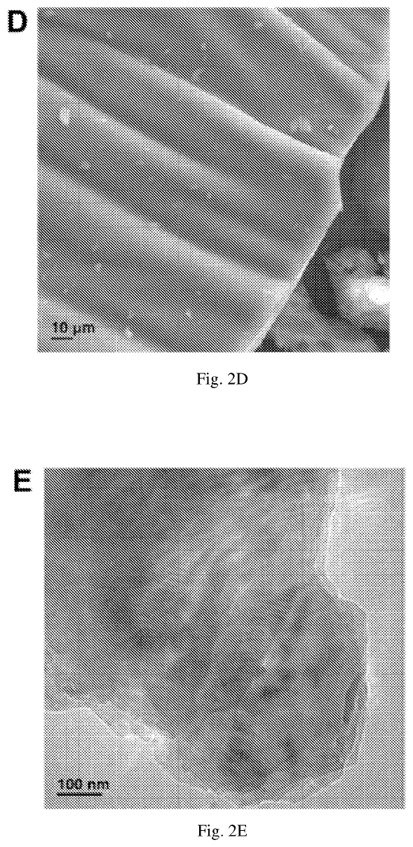

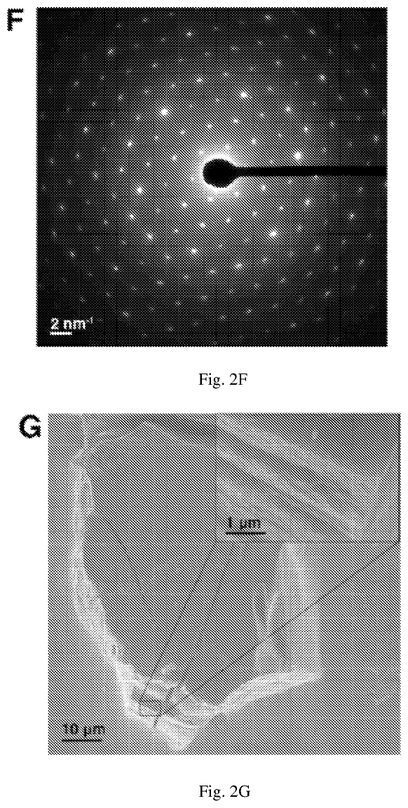

In this example, we demonstrate that under appropriately adjusted Sonogashira coupling conditions, an A₃B₃-type monomer, 1,3,5-tribromo-2,4,6-triethynylbenzene (TBTEB, FIG. 2), can be polymerized into extended γ-graphyne.

### Materials and Methods

### Materials

All reagents and solvents were acquired from commercial suppliers (Acros Organics, Sigma-Adrich, TCI Chemicals, Fisher Scientific, Oakwood Chemical and VWR International) and used without further purification, unless otherwise noted. Tetrahydrofuran (THF) was distilled over Na/benzophenone. Triethylamine (TEA) was distilled over CaH₂. Anhydrous pyridine (Py) was purchased from Acros in AcroSeal packaging and used without further purification. Copper foil, 1.0 mm thick Puratronic 99.999% (metals basis) with 25×50 mm lateral dimensions, was purchased from Alfa Aesar and cut into 5×10 mm pieces. These pieces of were then sequentially sonicated for 20 minutes in 3M HCl, water, ethanol, and acetone, dried under high vacuum at ambient temperature, and immediately used.

### Synthetic Methods

Reactions were monitored by thin-layer chromatography (TLC) carried out on 0.25 mm MilliporeSigma aluminum-backed silica gel plates (60F-254). Plates were visualized using 254 nm UV light and basic potassium permanganate stain (1.5 g KMnO₄, 0.5 g NaOH, and 10 g K₂CO₃ in 150 ml water, terminal alkynes stain yellow). Flash chromatography was performed on Luknova SuperSep™ (230-400 mesh) silica gel. Reactions requiring anhydrous or air-free conditions were performed under positive pressure of N₂ or Ar using standard Schlenk line techniques.

### Nuclear Magnetic Resonance (NMR) Spectrometry

NMR spectra were recorded on a Bruker Avance III HD 500 spectrometer operating at 500.24 (¹H), 125.79 (¹³C), or 99.37 (²⁹Si) MHz and equipped with Bruker Ascend 500 MHz US Narrow Bore Magnet and Broadband Prodigy TCI CryoProbe. NMR spectra were referenced to TMS (¹H, ¹³C, ²⁹Si) or residual solvent peaks. Chemical shifts (6) are reported in parts per million (ppm).

### Gas Chromatography-Mass Spectrometry

GC-MS analyses were performed on an Agilent 5977B GC/MSD instrument equipped with an Agilent 7890B automatic liquid sampler. Before injection of the sample, the 10 μL syringe was cleaned with acetone and ethyl acetate (3×10 μL each). 1 μL of the sample was then automatically injected into the instrument. The method used a 3-minute solvent delay. The oven was initially set at 60° C. and held at this temperature for 2.25 minutes before increasing the temperature to 225° C. at 35° C./min rate. Data analysis was performed using Agilent MassHunter Qualitative Analysis Navigator.

### Infrared Spectroscopy

Routine small molecule FTIR spectra were collected on an Agilent Cary 630 FTIR instrument equipped with single-reflection germanium or diamond attenuated total reflectance (ATR) modules. The instrument was calibrated before sampling against a newly cleaned (acetone) and dried crystal surface. Solid samples were placed directly on the crystal and secured with a needle press. 32 scans from 4000 to 550 cm⁻¹ were recorded. A background was collected for each sample (512 scans).

### Melting Points

Melting points were determined with a Mettler Toledo MP50 Melting Point System.

### Preparation of Exfoliated Samples

Analyte dispersions in water (1 mg/mL) were prepared by ultrasonication using a Branson SFX550 Sonifier. A ⅛″ double-step microtip (Branson p/n 101-063-212) was used. Samples were processed for 15 minutes at 50% amplitude.

### Scanning Electron Microscopy (SEM)

The SEM images of FIGS. 2G and 23 were acquired on an FEI Apreo 2 SEM operating at 5 kV and an FEI Inspect F-50 operating at 30 kV, respectively. For these images, dried material was added to carbon tape and mounted on SEM sample stands and sputtered with a thin layer of gold.

### Transmission Electron Microscopy (TEM) and Selected Area Electron Diffraction (SAED)

Exfoliated samples were analyzed by TEM. Prior to sample preparation, 200-Cu C—B grids were plasma-treated for 30 seconds using an Emitech K100× glow discharger. 3 μL of sample dispersion was added to the grid and allowed to absorb for 5 minutes before the excess solvent was wicked. The grid was then transferred to a single-tilt sample holder and imaged on an FEI Tecnai 20 TEM operating at 200 kV in low-dose mode. Images were recorded on a Tvips F416. Data was collected using SerialEM software. Tilting was performed with the equipped alpha-rotation goniometer.

SAED patterns were recorded on an FEI Tecnai 20 TEM using a 40 μm selected area aperture and in the absence of the selected area aperture. The obtained patterns were calibrated against the (111) planes of evaporated aluminum (plane spacing 0.2338 nm) on a 3 mm grid. The calibration sample was purchased from Electron Microscopy Sciences (EMS p/n 80044).

### X-Ray Photoelectron Spectroscopy (XPS)

Samples were spread onto double-sided copper tape for XPS analysis. Surveys and high-resolution spectra were acquired on a PHI VersaProbe II Scanning XPS Microprobe using a monochromatic Al X-ray at pressures of 10⁻¹⁰ to 10⁻⁷ Torr. The data was smoothed by using the Savitzky-Golay method, with a smoothing width of five, and analyzed using CasaXPS software.

A Tougaard background was applied to each peak before deconvolution. All peak fits used generalized Voigt-like peak shapes, as this function is most appropriate for fitting asymmetric XPS signals. CasaXPS provides a generalized Voigt function described as Lorentzian Finite: LF(α, β, w, n, m), where the first three parameters (α, β, w) affect the Lorentzian line shape and its asymmetry and the final two (n, m) change the width of the Gaussian function and the number of times convolution with the Lorentzian component occurs. Symmetrical peak parameters for the LF line shape were used: LF(1, 1, 255, 360, 6), values derived from default symmetric peak shape settings for CasaXPS. All sub-peak widths were constrained to full width at half maximum (FWHM) of 1.6 eV or less. The subpeaks are located at 283.7 eV (terminal alkyne sp¹), 284.6 eV (aromatic sp²), 285.3 eV (internal alkyne sp¹), 286.9 eV (aromatic C—Br), and 288.5 eV (carbonyl C═O). All peaks were allowed a ±0.2 eV padding to the peak position.

### Computation and Modeling

### Density Functional Theory (DFT) Calculations

All DFT calculations were performed using 2D periodic boundary conditions via the RIPER module of TURBOMOLE7.5. In all cases the PBE density functional with D3 dispersion corrections and Becke-Johnson damping was used. All the calculated geometries were in broad agreement with prior computational studies of γ-graphyne.

Potential energy surfaces of both a γ-graphyne bilayer and individual molecules/graphyne supercells were computed as a function of the horizontal offset of the upper γ-graphyne layer or molecule relative to the lower layer with a fixed interlayer distance of 3.35 Å. Binding energies for each structure were calculated as adsorption energies (EE_{binding}=EE_{bilayer}−EE_{separated)}. A 9×9 k-point grid was used for the γ-graphyne bilayer structures. The monomer/graphyne supercells were built using a 3×3 γ-graphyne monolayer to ensure 1 nm spacing between adjacent periodic images of monomers. Due to the resulting repetitiveness of these supercells, a coarser 3×3 k-point grid was used throughout the potential energy surface scan calculations. The def2-SVP basis set was used throughout.

Local bilayer minima identified from the potential energy surfaces were refined by geometry optimization with the def2-TZVP basis set and a 9×9 k-point grid. Similarly, selected binding site supercell structures were optimized with def2-SVP and a 9×9 k-point grid. Final binding energies for all structures were calculated with def2-TZVP as well, along with a finer 17×17 k-point grid.

### SAED Simulations

The lattice parameters and bond lengths were obtained from DFT calculations (vide supra) and a previously published computational study. SAED and PXRD simulations were performed using the CrystalMaker software suite. A model of a single γ-graphyne sheet was built in CrystalMaker using a hexagonal P6 lattice with parameters a and c set to 6.86 Å and 3.4 Å, respectively. The asymmetric unit comprised four atoms placed at 0.208, 0.412, 0.589, 0.795 along the hexagonal P6 x axis. The basic models corresponding to various sheet stacking modes were constructed using Vesta.

### Small Molecule Synthesis

### 1,3,5-tribromo-2,4,6-triiodobenzene

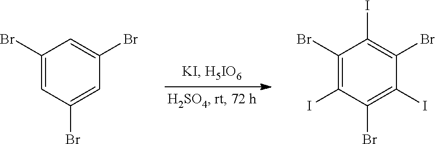 [SMILES: Brc1cc(Br)cc(Br)c1 ; Brc1c(I)c(Br)c(I)c(Br)c1I]

The synthesis procedure for 1,3,5-tribromo-2,4,6-triiodobenzene was adapted from the literature. To concentrated H₂SO₄ (500 mL) at room temperature was added periodic acid (41.03 g, 180 mmol) in small portions over 15 min. After dissolution of the periodic acid, crushed KI (89.64 g, 540 mmol) was added in small portions at 0° C. over 1 h. To the resulting deep purple solution at 0° C. was added 1,3,5-tribromobenzene (18.89 g, 60.0 mmol) in small portions over 25 min. After the solution was stirred at room temperature for 72 h, the resulting thick mixture was poured onto ice. The resulting precipitate was filtered and washed with H₂O (5×200 mL) and then MeOH (5×200 mL). The product was recrystallized twice from pyridine/EtOH 1:4 (1000 mL) to yield a solid. The solid was dried at under high vacuum for 1 day to give 1,3,5-tribromo-2,4,6-triiodobenzene 2 (28 g, 67%) as a pale-yellow solid. Mp>300° C. (decomposition); FTIR (neat) vmax=1488, 1354, 1262, 1227, 1147, 1002, 858, 771, 739, 554, 508 cm⁻¹. ¹³C NMR (126 MHz, DMSO-d6) δ 138.61 (CBr), 108.23 (CI). EI-MS fragmentation: m/z 695.5, 693.5, 691.5, 689.5, 567.6, 566.6, 565.6, 564.6, 439.7, 437.6. UV/vis (CHCl₃, C=6.874×10⁻⁵ M): λ max (ε)=227 (5000), 248 (27700), 283 (5600 M⁻¹cm⁻¹).

### ((2,4,6-tribromobenzene-1,3,5-triyl)tris(ethyne-2,1-diyl))tris(trimethylsilane)

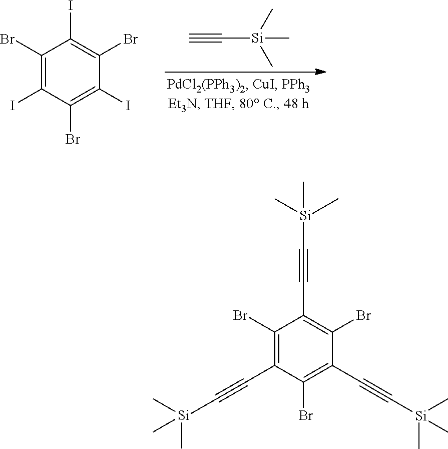

1,3,5-tribromo-2,4,6-triiodobenzene 2 (346 mg, 0.5 mmol), [PdCl₂(PPh₃)₂] (105 mg, 0.15 mmol, 30 mol %), CuI (19 mg, 0.1 mmol, 20 mol %), Et3N (50 mL) and THF (40 mL) were added to a dry three-necked flask. Ethynyltrimethylsilane (736.7 mg, 1.07 mL, 7.5 mmol) and Ph₃P (52 mg, 0.2 mmol, 40 mol %) were added to the mixture. The mixture was stirred at 80° C. for 48 h under argon. After the removal of solvent on a rotary evaporator, DCM (100 mL) was added to the residue and filtered through Celite. The mixture was washed with water (20 mL) and NaCl(aq) (20 mL), dried over anhydrous Na₂SO₄, and the solvent was removed under reduced pressure. The residue was further purified by flash chromatography using n-hexane as the eluent to yield ((2,4,6-tribromobenzene-1,3,5-triyl)tris(ethyne-2,1-diyl))tris(trimethylsilane) 3 as a white solid (175 mg, 0.29 mmol, yield: 58%). Rf (hexane)=0.3. Mp=110-111° C.; FTIR (neat) vmax=2958, 2160, 1376, 1340, 1245, 1019, 834, 758, 708, 658, 633, 539 cm⁻¹. ¹H NMR (500 MHz, CDCl₃): δ=0.29 ppm [s, 27H, Si(CH₃)₃]. ¹³C NMR (126 MHz, CDCl₃): δ 129.09 (CBr), 127.49 (C6C≡C), 106.79 (C≡CSi), 101.83 (C6C≡C), −0.23 [Si(CH3)3] ppm. ²⁹Si NMR (99 MHz, CDCl₃) δ −15.87 ppm. EI-MS fragmentation: m/z 603.9, 602, 601.9, 590.9, 589.9. 588.9, 588.9, 587.9, 586.9, 584.9. UV/vis (CHCl₃, C=5.436×10⁻⁵ M): λ max (ε)=260 (45700), 271 (44600), 289 (39600 M⁻¹-cm⁻¹).

### 1,3,5-tribromo-2,4,6-triethynylbenzene, TBTEB

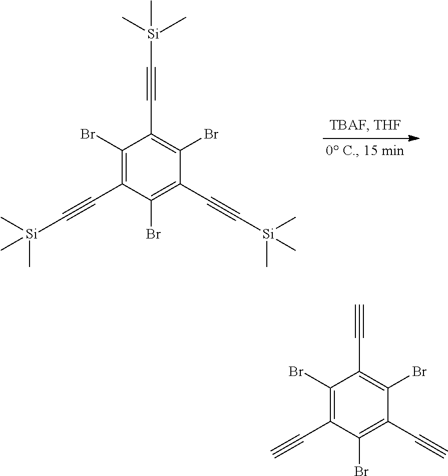

To a solution of ((2,4,6-tribromobenzene-1,3,5-triyl)tris(ethyne-2,1-diyl))tris(trimethylsilane) (151 mg, 0.25 mmol) in THF (15 mL) was added 0.55 mL TBAF (75% solution in water, 1.5 mmol) and stirred at 0° C. for 15 min. The solution was then diluted with ethyl acetate and washed with distilled water and dried with anhydrous Na₂SO₄. The solvent was removed on a rotary evaporator. The residue was further purified by flash chromatography using n-hexane as the eluent to give TBTEB as a white solid (84 mg, 0.216 mmol, yield: 87%). Rf (hexane)=0.2. FTIR (neat) vmax=3275, 2922, 2112, 1519, 1368, 1336, 965, 736, 681, 634 cm⁻¹. ¹H NMR (500 MHz, CDCl₃): δ=5.16 (s, 3H, (C≡CH) ppm. ¹³C NMR (126 MHz, CDCl₃): 129.90 (CBr), 126.33 (C6C≡CH), 91.87 (C≡CH), 80.97 (C6C≡CH) ppm. EI-MS fragmentation: m/z 390.8, 389.9, 388.8, 387.8, 386.8, 385.8, 384.8, 383.8. UV/vis (CHCl₃, C=4.136×10⁻⁵ M): λ max (ε)=212 (7100), 218 (8300), 260 (58100), 278 nm (33500 M⁻¹ cm⁻¹).

### Synthesis of Carbon Materials

TABLE 1
Representative Polymerization Reactions of TBTEB^{a}

| | | | Additive/ | Solvent/ | Temp, | Time, | |
|---|---|---|---|---|---|---|---|
| Entry | [Pd]/mol % | [Cu]/mol % | mol % | Base | ° C. | h | Product |
| 1 | Pd(PPh₃)₄/100% | CuI/8% | — | Pyridine | 110 | 72 | High |
| | | | | | | | crystallinity |
| 2 | Pd(PPh₃)₄/100% | Cu foil¹ | — | Pyridine | 110 | 48 | Low |
| | | | | | | | crystallinity |
| 3 | Pd(PPh₃)₄/100% | — | — | Pyridine | 110 | 72 | amorphous |
| 4 | — | — | — | Pyridine | 110 | 72 | amorphous |
| 5 | PdCl₂(PPh₃)₂/30% | Cu/Si | Ph₃P/40% | THF/Et₃N | 80 | 48 | amorphous |
| | | | | (44:56) | | | |
| 6 | — | Cu/Si | — | Pyridine | 110 | 72 | amorphous |
| 7 | — | Cu wire | — | Pyridine | 110 | 72 | amorphous |
| 8 | Pd(PPh₃)₄/100% | Cu wire | — | Pyridine | 110 | 72 | Low |
| | | | | | | | crystallinity |
| 9 | — | Cu wire¹ | — | Pyridine | 100 | 72 | amorphous |
| 10 | Pd(PPh₃)4/40% | — | — | Pyridine | 100 | 48 | amorphous |
| 11 | Pd(PPh₃)₄/100% | Cu/Si | — | Pyridine | 110 | 72 | amorphous |
| 12 | — | Cu foil¹ | — | Pyridine | 110 | 72 | amorphous |
| 13 | PdCl₂(PPh₃)₂/60% | Cu/Si | Ph₃P/80% | THF/Et₃N | 80 | 72 | amorphous |
| | | | | (1:1) | | | |
| 14 | — | Cu foil | — | Pyridine | 70 | 72 | No Material |

¹Copper foil was treated by sonicating in 3M HCl, water, ethanol, and acetone, sequentially, for 20 minutes, dried under vacuum at rt and used immediately.
^{a}All the reactions were performed under positive pressure of Ar (Schlenk line with a Hg bubbler).

### General Synthetic Procedure for Carbon Materials

In a typical procedure, TBTEB, Pd(PPh₃)₄, and Cu were charged to a Schlenk tube under argon atmosphere and solvent was added. The tube was sealed, and the contents degassed by three freeze-pump-thaw cycles. The reaction mixture was stirred under argon atmosphere and heated for 72 hours. The reaction mixture was concentrated on a rotary evaporator. The solid product was washed with methanol, ethanol, isopropanol, toluene, hexanes, ethyl acetate and acetone. The washing procedure involved dispersing the material in the corresponding solvent by gentle sonication, followed by centrifugation. Conditions for selected experiments from Table 1 are detailed below.

### Table 1, Entry 1

TBTEB (116 mg, 0.3 mmol), Pd(PPh₃)₄ (347 mg, 0.3 mmol) and CuI (4.6 mg, 0.024 mmol) reacted in anhydrous pyridine (50 mL) using the general procedure. Typical mass of the crude product after centrifugation and drying on low vacuum (1-2 Torr) over 10 hours was ˜90% of the monomer mass (104 mg for the scale above). After extensive drying at high vacuum (10 mTorr) and/or heating to 100° C. for 72 hours the mass decreased to ˜60% of the original monomer mass (68 mg for the scale above). TLC indicated monomer conversion is quantitative.

### Table 1, Entry 2

TBTEB (116 mg, 0.3 mmol), Pd(PPh₃)₄ (347 mg, 0.3 mmol) and several pieces of copper foil reacted in a mixture of anhydrous pyridine (50 mL) using the general procedure.

### Table 1, Entry 3

TBTEB (116 mg, 0.3 mmol) and Pd(PPh₃)₄ (347 mg, 0.3 mmol) reacted in pyridine (50 mL) using the general procedure. No Cu was used.

### Table 1, Entry 4

TBTEB (116 mg, 0.3 mmol) refluxed in pyridine (50 mL). Neither Pd(PPh₃)₄ nor copper was used.

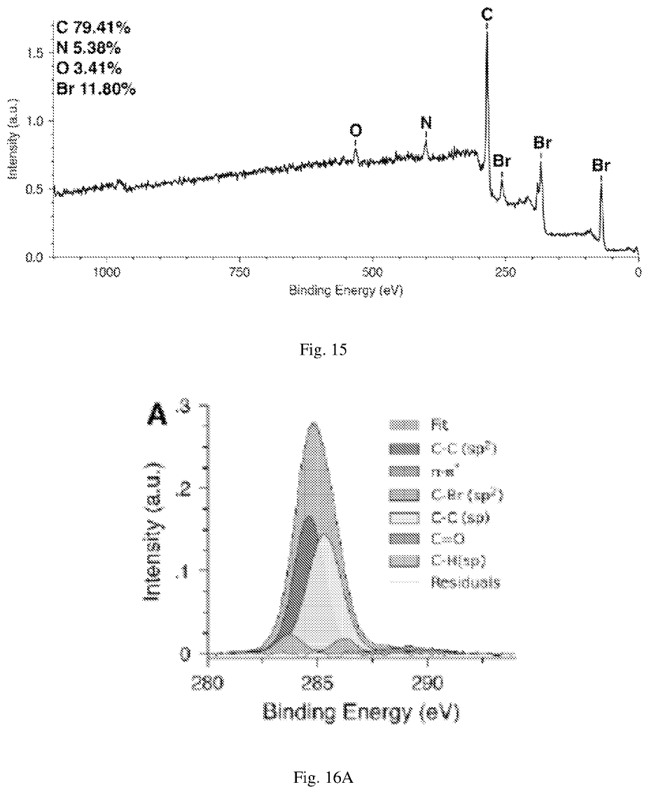

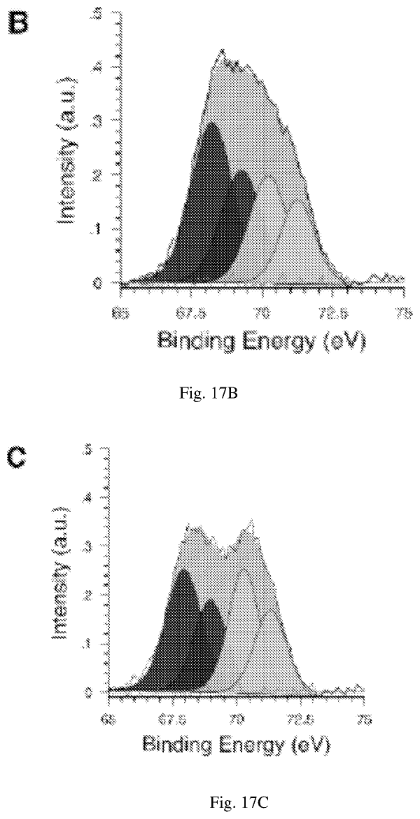

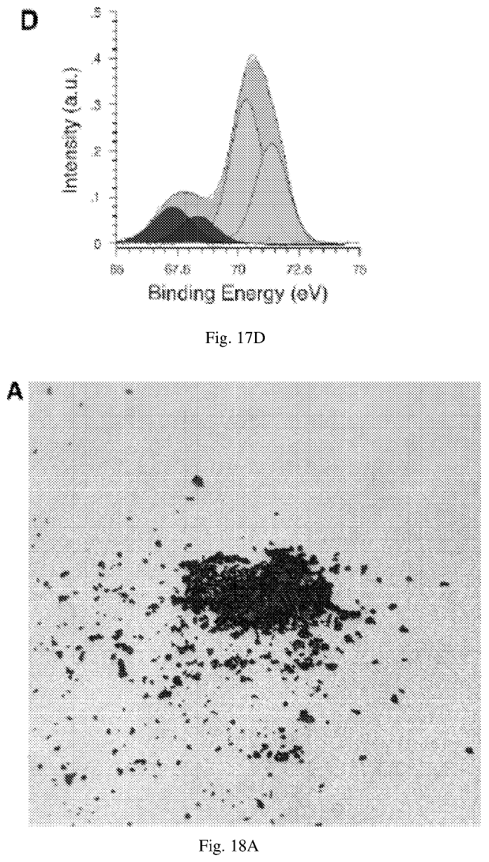

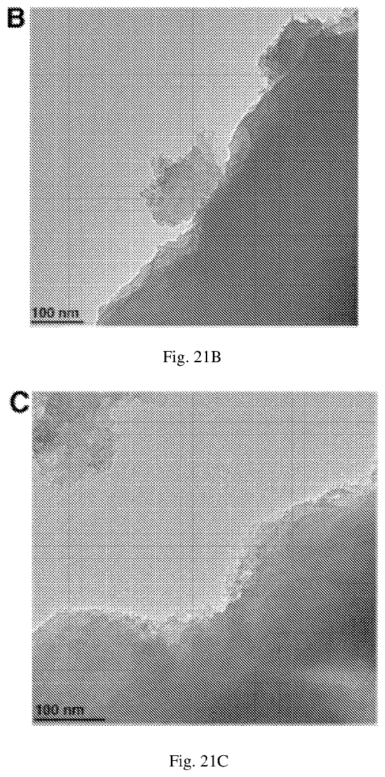

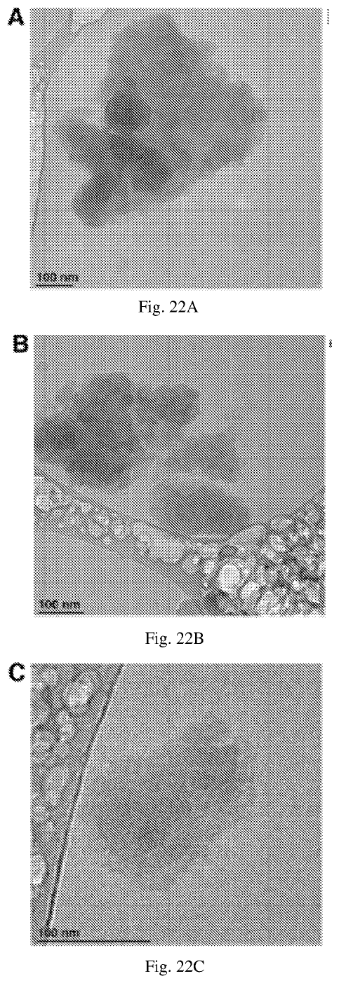

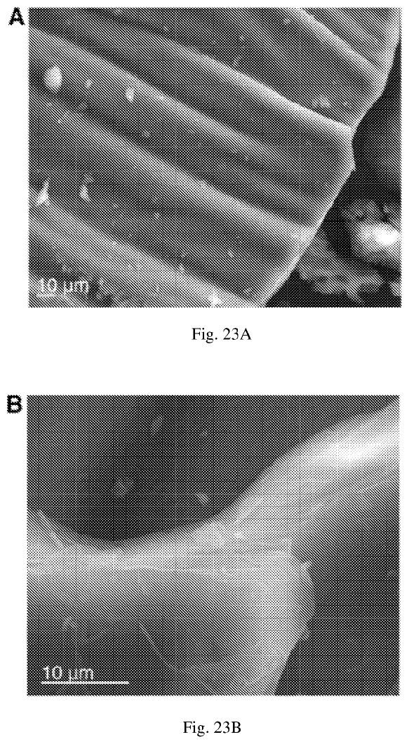

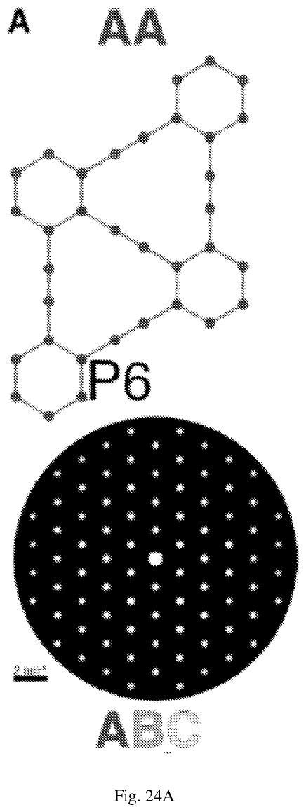

TBTEB was synthesized following a reported procedure. Its reactivity was then screened under a range of conditions (Table 1). In the absence of catalysts, TBTEB decomposes in refluxing pyridine with a half-life of ˜24 hours, yielding amorphous carbonaceous material (FIG. 22). X-ray photoelectron spectroscopy (XPS) survey indicated moderate loss of Br through spontaneous hydrodebromination (FIGS. 15 and 17D). A similar featureless carbon was produced in the presence of Pd(PPh₃)₄ (FIG. 21), albeit with a more significant Br loss (FIGS. 14 and 17C).

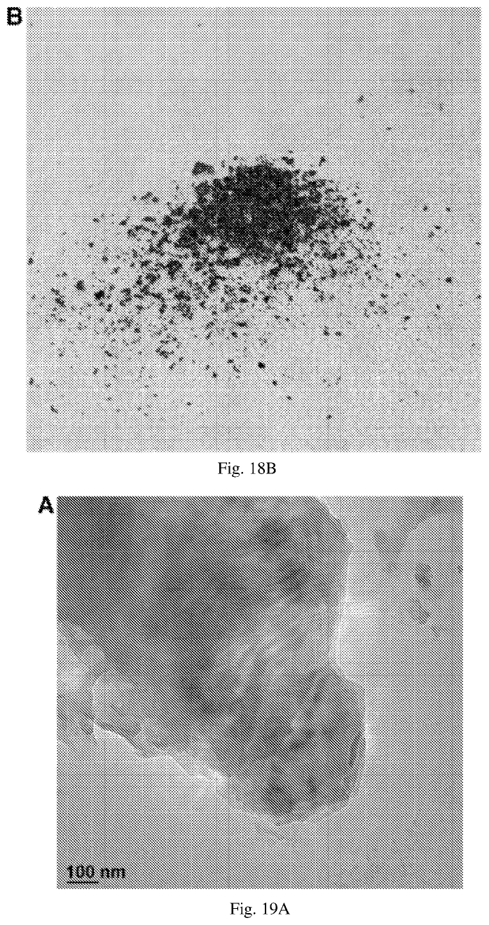

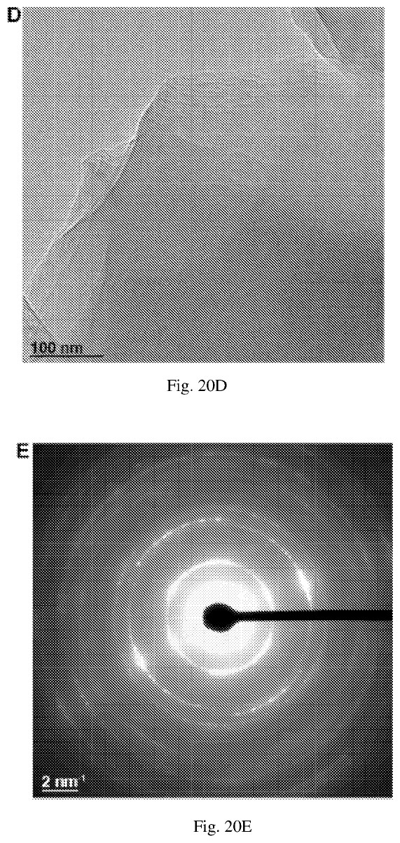

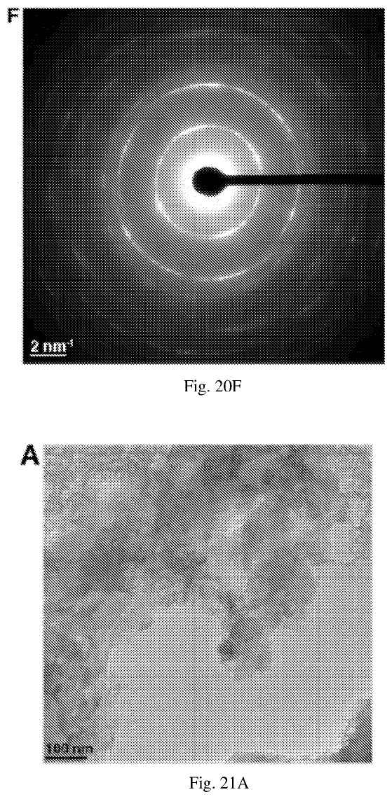

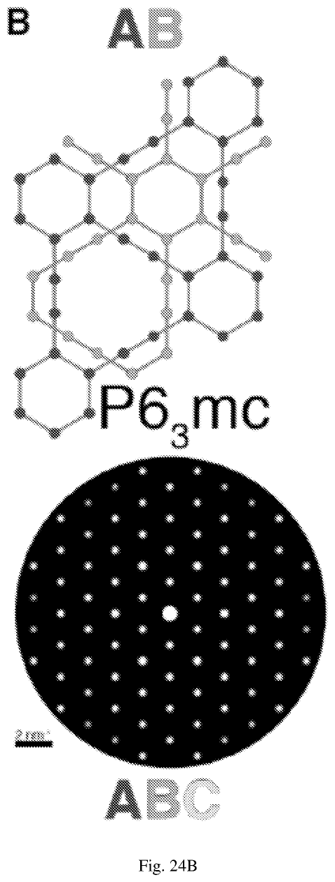

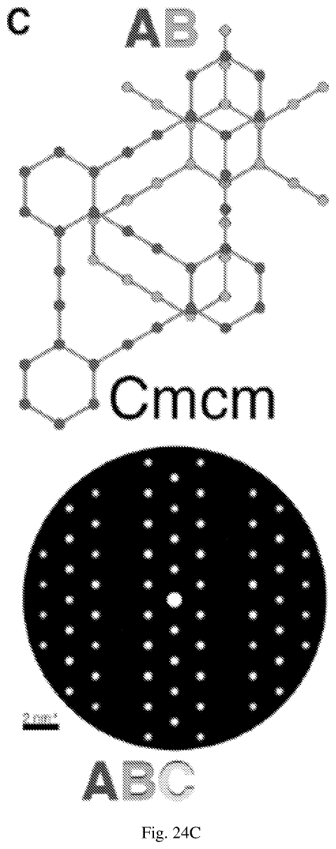

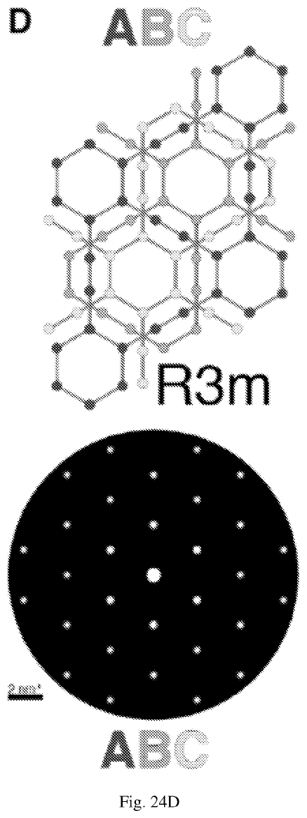

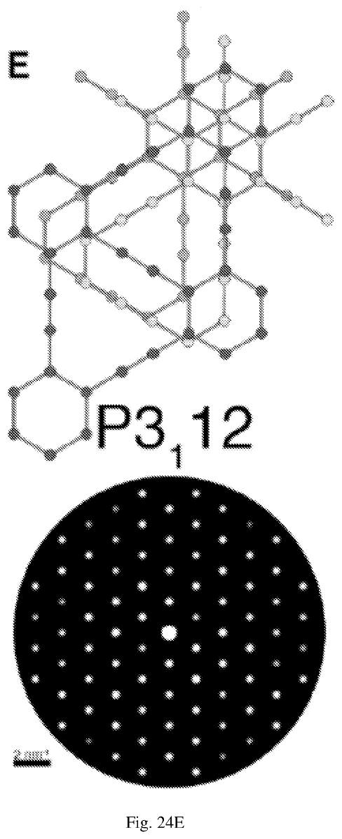

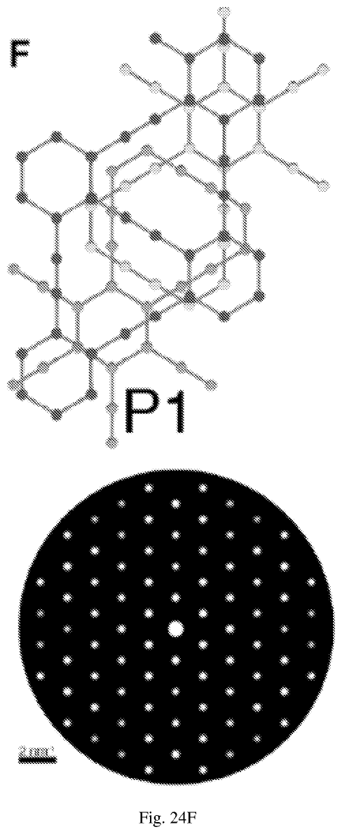

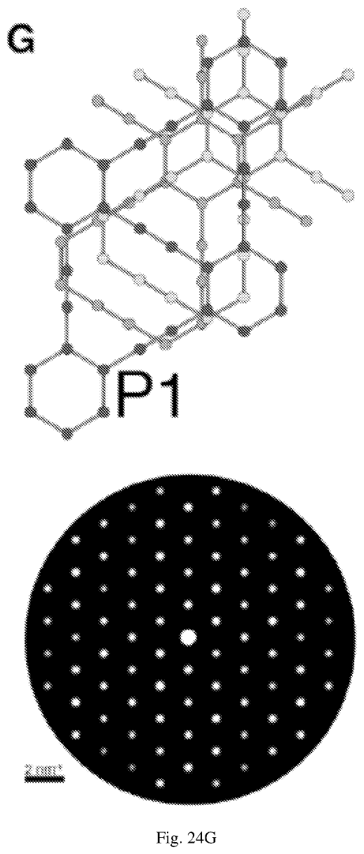

Experiments performed in the presence of both Pd and Cu produced outcomes dependent on the state of the metals. Pd(II) pre-catalysts, as well as PEPPSI-IPr, which we selected for its propensity for multi-site coupling, yielded amorphous carbons broadly comparable to the control products. However, with a stoichiometric loading of Pd(PPh₃)₄ in the presence of Cu foil, we obtained black lustrous material (FIG. 18B). Transmission electron microscopy (TEM) images of this material revealed flakes composed of stacks of flat sheets (FIG. 20). The layered morphology was corroborated by the scanning electron microscopy (SEM) images of the flakes (FIG. 24). Despite the well-defined layers, no Moiré patterns were observed in TEM. Selected area electron diffraction (SAED) experiments produced dotted ring patterns (FIGS. 20E-F), indicating sub-micron crystalline domains with random orientation.

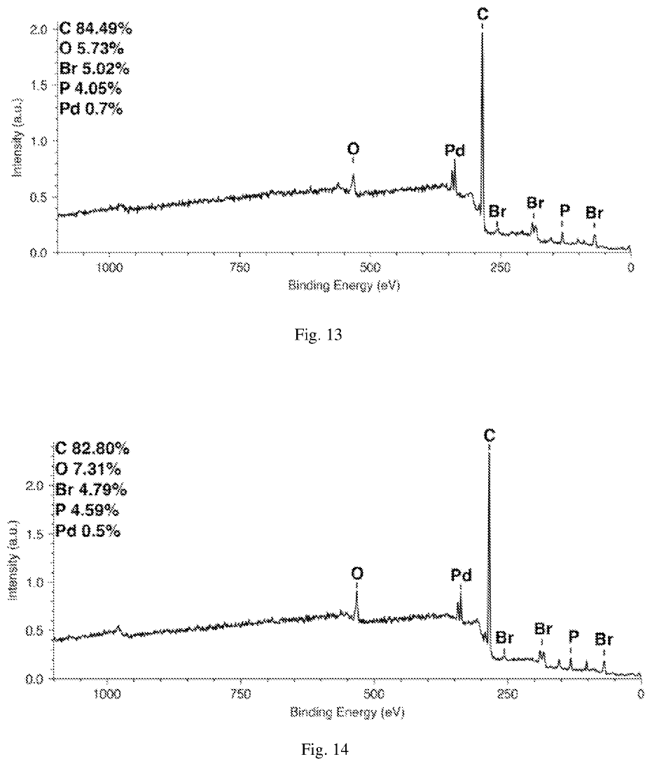

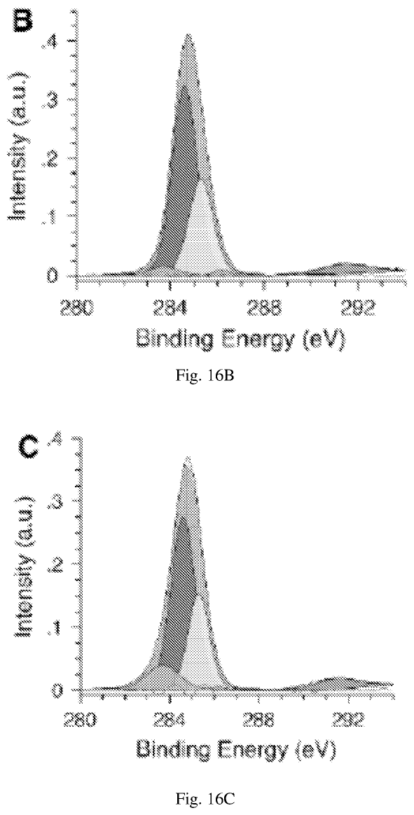

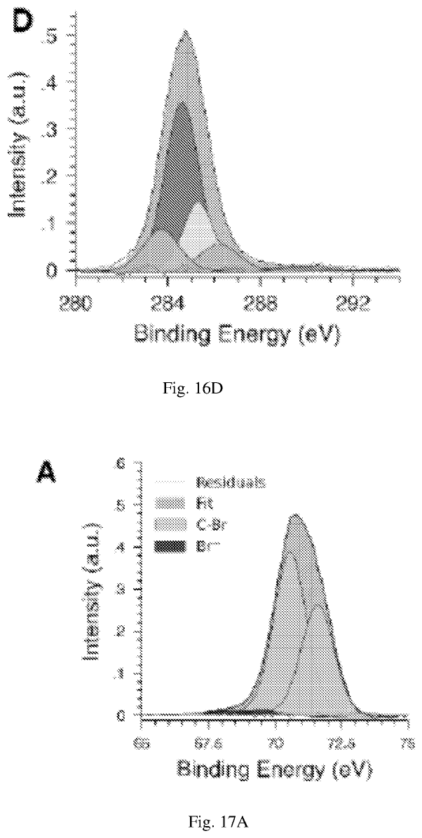

A product of higher crystallinity was obtained through an optimized homogeneous Pd(PPh₃)₄/CuI protocol, which allowed for efficient removal of contaminants. Survey XPS of this product indicated a level of contamination with Pd and P that was below the detection limit of the technique (FIG. 12). We acquired high-resolution XPS data for the Cis region of this material (FIG. 2D), as well as for three controls: the product of a Cu foil synthesis, a Pd-only reaction, and thermal reaction products (FIG. 12). The C1s peak can be deconvolved into five sub-peaks, corresponding to C—H (terminal alkyne sp¹), C≡C (internal alkyne sp¹), C═C (aromatic sp²), aromatic C—Br, and C═O carbons. The contribution of C═O is negligible for all samples, indicating little to no oxidation under the reducing/anaerobic reaction conditions. Without the contribution of the sp¹ subpeak, none of the fits converge, which strongly supports the presence of acetylenic bonds in all products. XPS indicates a 1:1 ratio of sp¹ to sp² carbons in the crystalline material synthesized by the homogeneous Pd(PPh₃)₄/CuI protocol, which is consistent with γ-graphyne. This ratio is much higher in the control samples (FIGS. 16B-D), due to extensive side reactions and contamination with aromatic impurities. The π-π* “shake up” peak at 290 eV is commonly observed in XPS of graphitic carbons and graphene, as well as small aromatic molecules. Notably, this peak does not appear in the XPS of graphdiyne. The “shake up” feature was negligible for the product of the homogeneous Cu protocol (FIG. 2D), strongly suggesting that this material is not graphitic. The peak was prominent for the control products that were also contaminated with P (FIGS. 13, 14, and 16C-D), indicating that it may be related to adsorbed PPh₃.

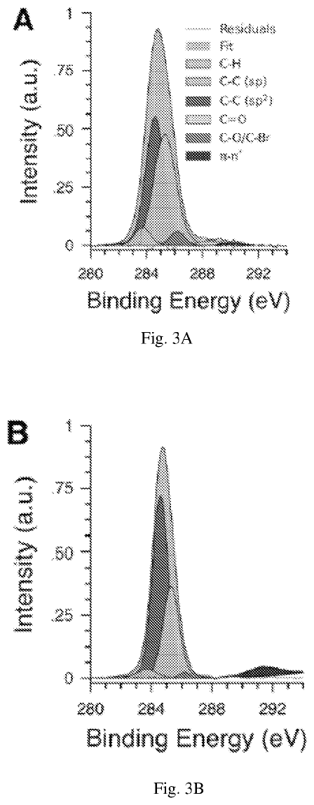

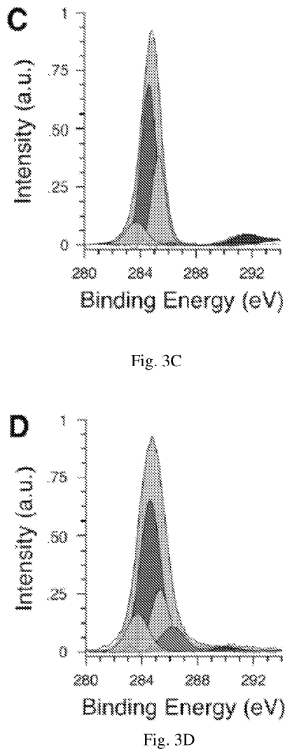

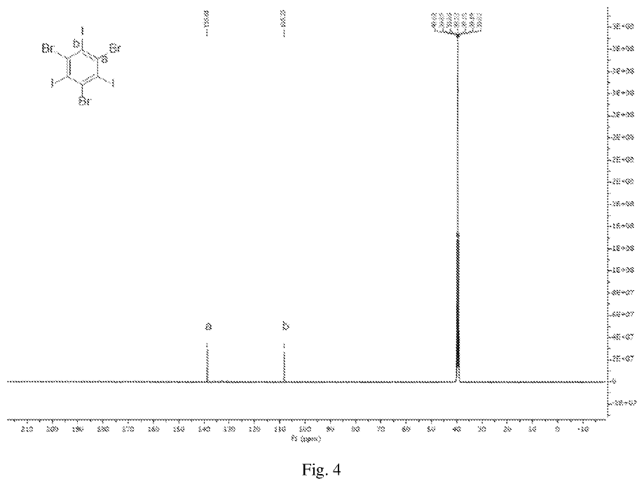

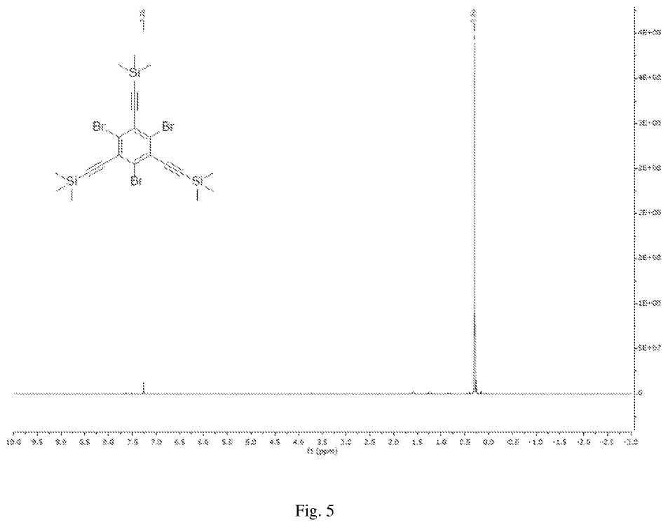

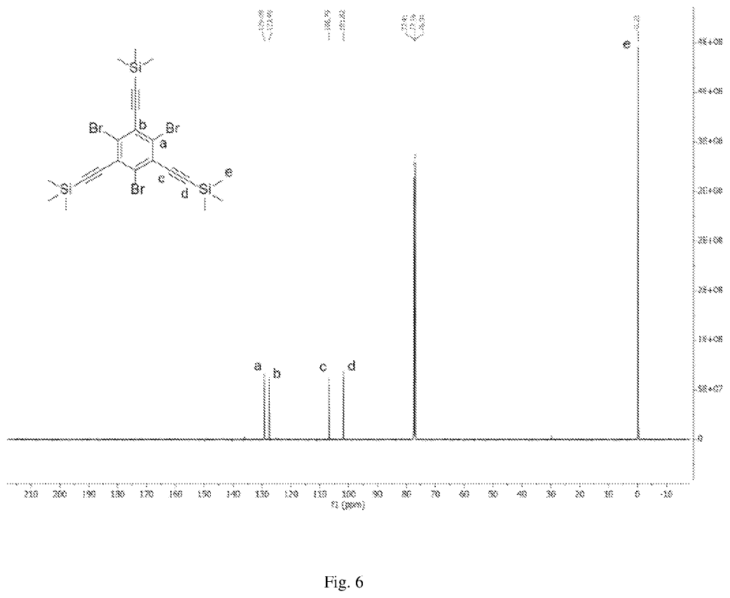

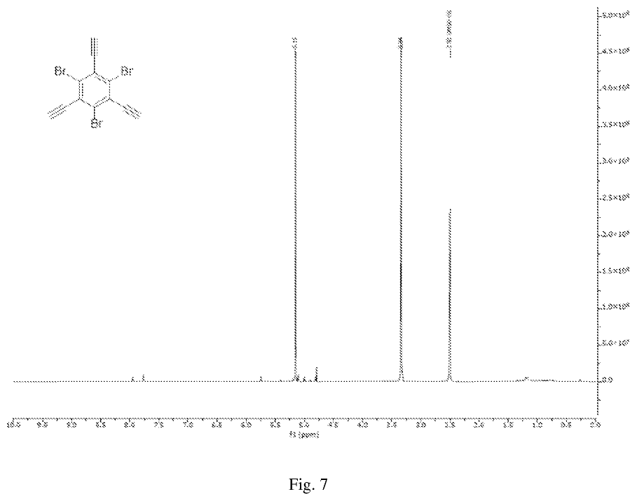

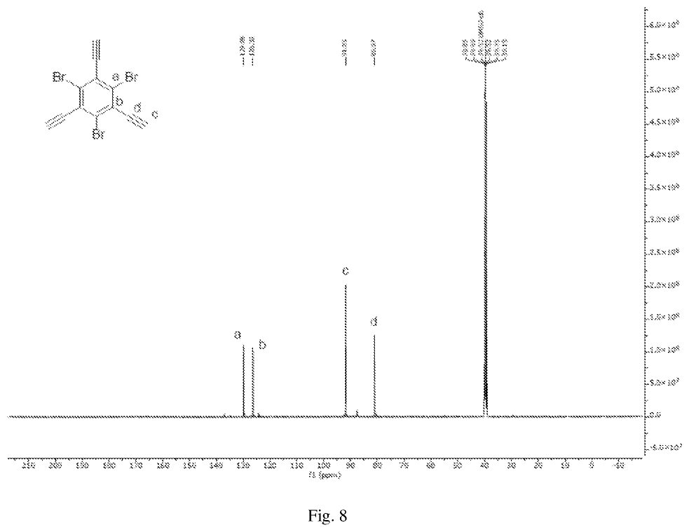

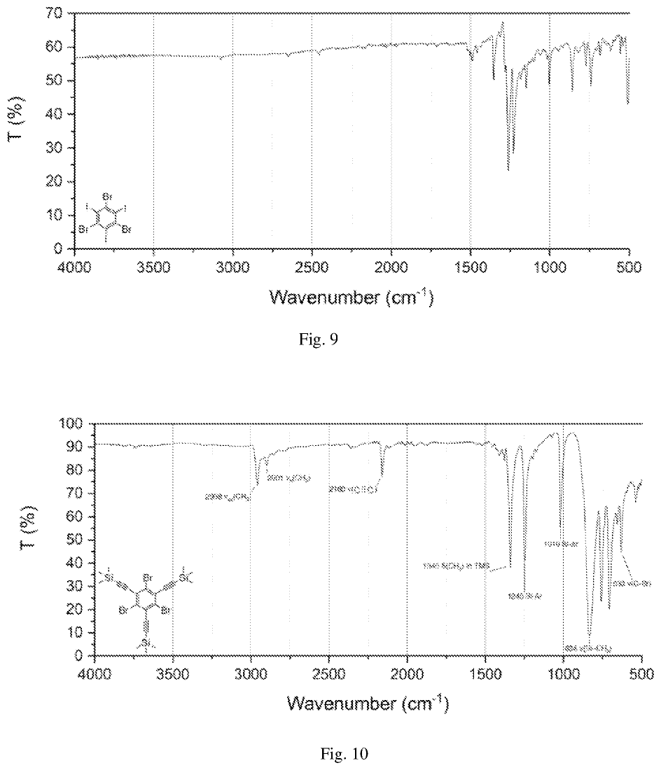

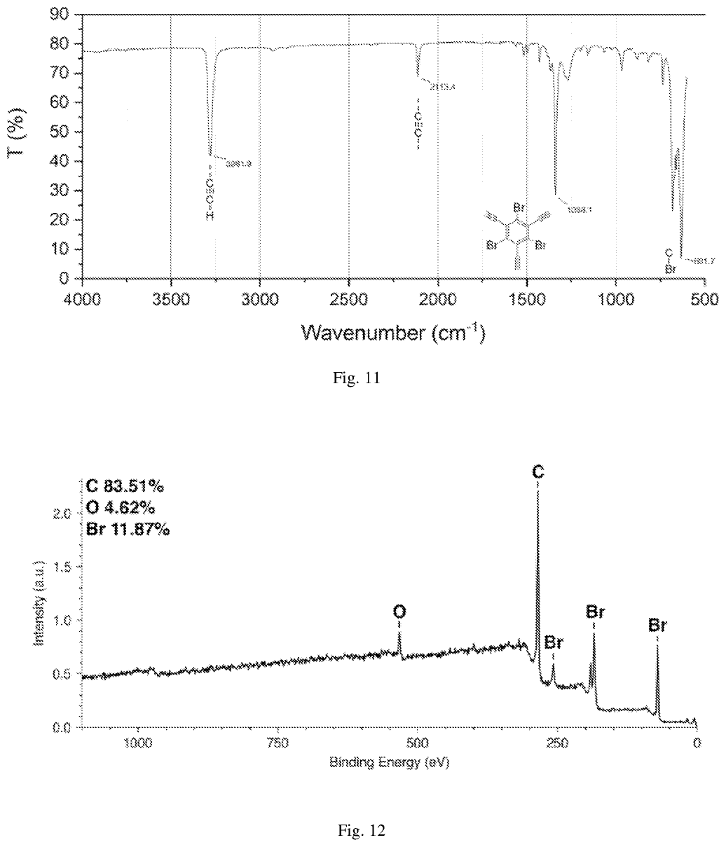

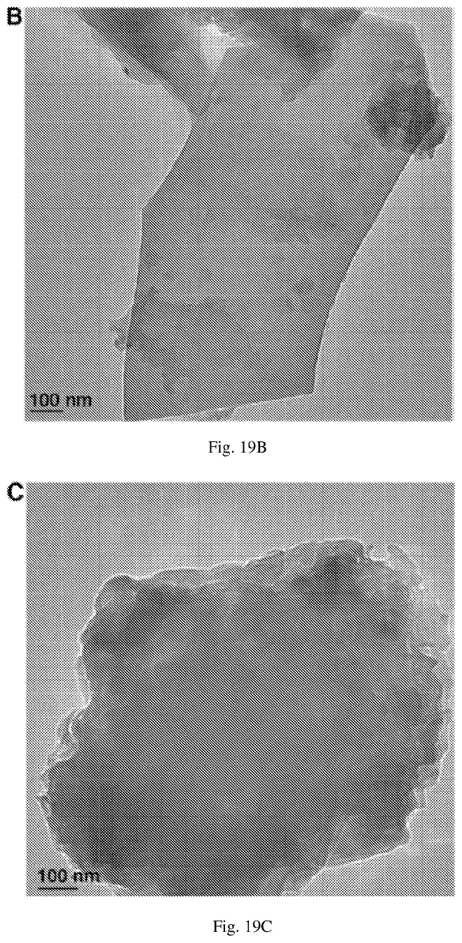

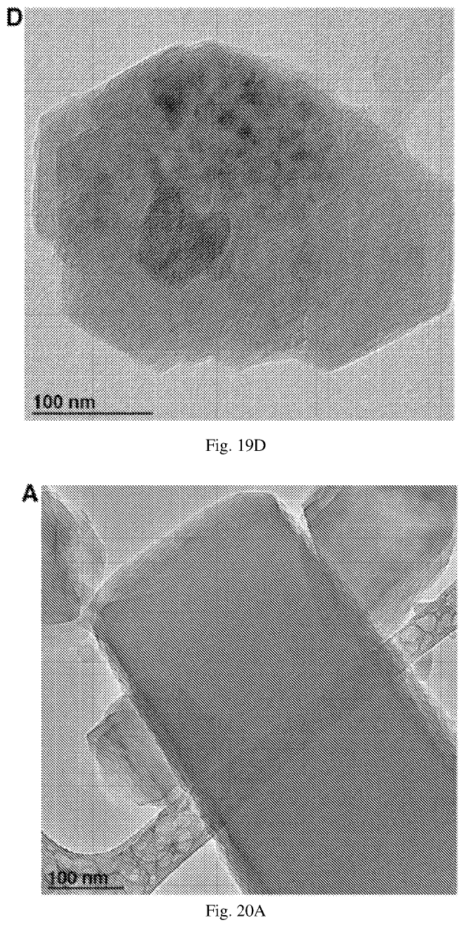

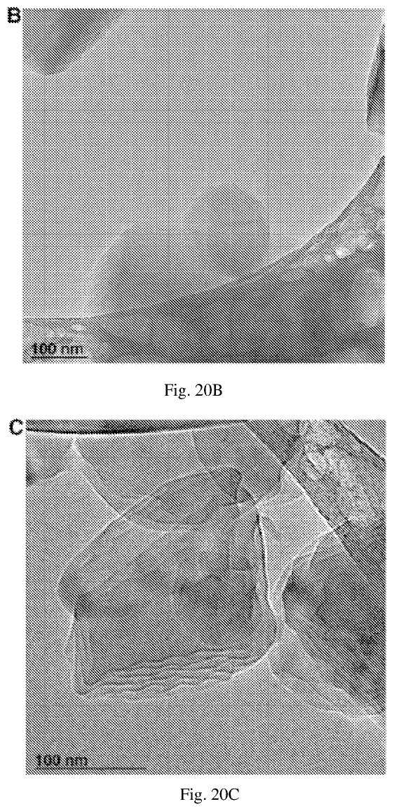

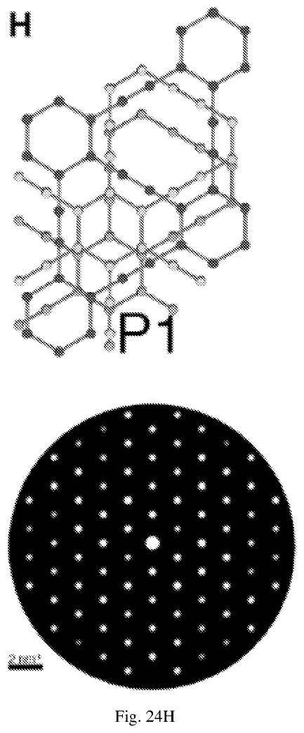

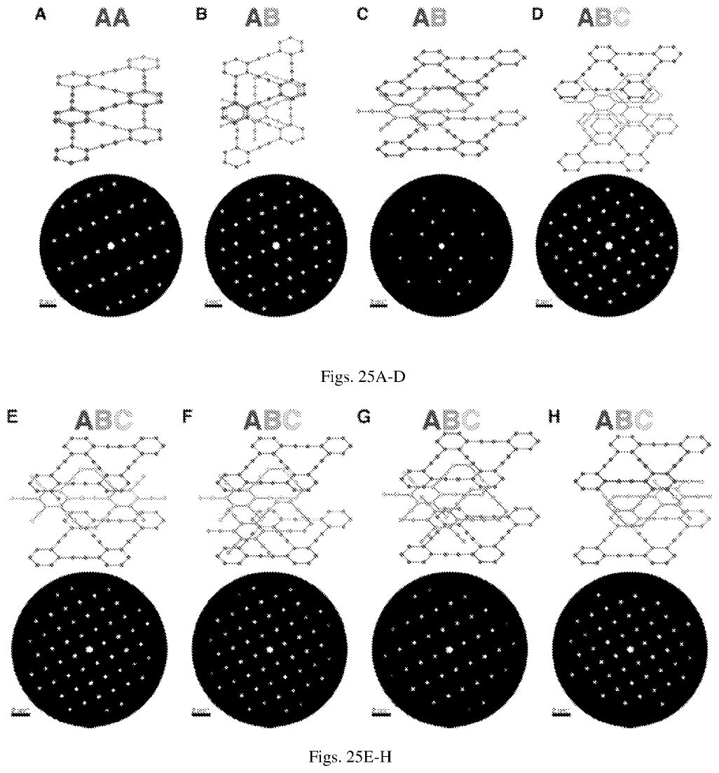

We further explored the structure and symmetry of the crystals using electron diffraction. The spot SAED patterns of the product obtained with the Pd(PPh₃)₄/CuI protocol were exceptionally well-defined, consistent for different regions of the sample, and independent of the size or presence of a selected area aperture. The near-perfect uniformity of the patterns indicates that the material consists of crystalline domains that are sufficiently large to span the entire illuminated region of our typical imaging frame of 2×2 μm (FIGS. 2B and 19), indicating crystalline domain sizes of at least 1-3 μm. The diffraction patterns observed from the flat areas of the sample had perfect hexagonal symmetry (FIG. 3B). Using interatomic distances calculated by DFT, we built models for several plausible stacking modes of γ-graphyne. These models were used to simulate electron diffraction in the c, b, and intermediate crystal orientations that lie ˜45° to the (0001) pole (FIG. 25). The simulated c orientation patterns exclusively involve spacings in the basal plane (FIGS. 24C and 24D). The first- and second-order reflections in the experimental diffraction pattern correspond to d-spacings of 5.96 Å and 3.44 Å, which perfectly match the theoretically calculated spacings for the (1010) and (1120) and plane sets of γ-graphyne (FIGS. 3B and 3D). Both of these distances are defined in part by the length of the acetylenic bond. Some of the more symmetric space groups, such as Cmcm and R3m, are expected to produce diffraction patterns with systematic absences. Since there were no such systematic absences in the observed diffraction pattern, these space groups could be conclusively eliminated.

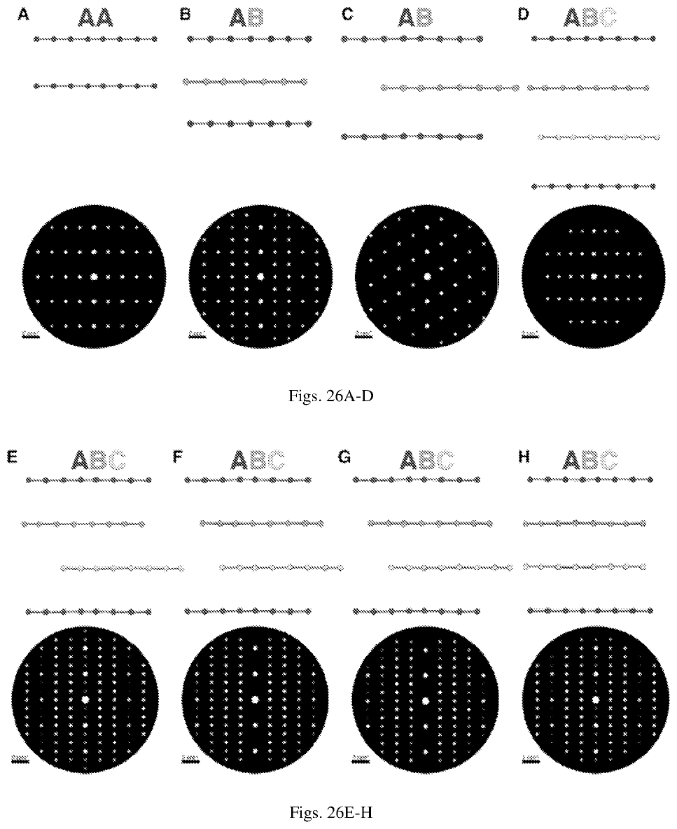

Additional SAED patterns were obtained for an alternate sample orientation. The initial position of the stage was chosen to yield the most symmetric spot intensity distribution, which corresponds to a beam normal to the basal plane and coincident with the a axis. Then the sample was rotated around the b axis. As the sample rotation reached ˜45°, diffraction patterns that involve the z-spacings began to appear. The experimental diffractograms in this orientation provided groups of closely spaced spots (FIG. 3C), suggesting defects in the layer stacking. Such defects would not appear in the c orientation diffractograms, since the stacking mode only affects reflections involving z spacing (FIG. 26). The symmetry of the patterns agrees with our simulations for this intermediate orientation (FIGS. 25E, 25F, 25H). As no systematic absences were observed, we can exclude some of the more symmetric space groups, most notably the P6₃mc space group. The experimental diffraction patterns were most consistent with either one of the lower symmetry stacking modes, such as P3₁12 (FIG. 25E) or an aperiodic superlattice. It is important to note that despite their multi-spot character, the observed diffractograms are not indicative of turbostratic stacking, which would produce ring patterns. The shape-factor effect alters the geometry of the diffracted beam, which introduces error into the determination of spot centers. However, modeling indicates that the alternate sample orientation diffractograms are consistent with an interlayer distance of approximately 3.5 Å.

Our data indicates that the material we synthesized is multilayer γ-graphyne. Contrary to expectations, we found that no external template is required for synthesizing highly crystalline γ-graphyne. There is no experimental evidence even in our reactions performed with Cu foil that any polymerization is happening on the surface. The lower crystallinity of the Cu foil products is likely due to the reduced concentration of catalytic Cu species in solution. This results in slower Sonogashira coupling and a higher extent of side reactions compared to the homogenous Pd(PPh₃)₄/CuI protocol.

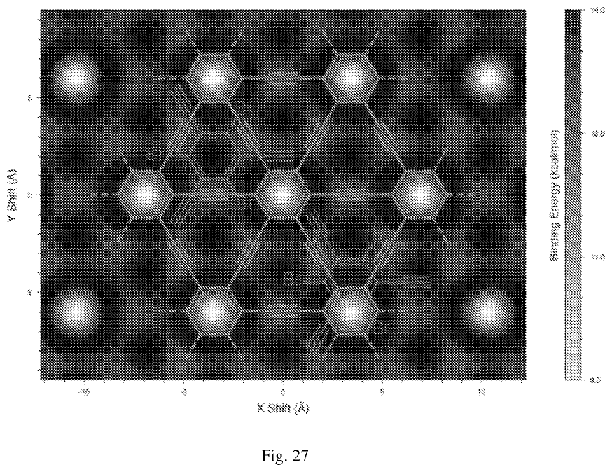

We tried to understand why TBTEB preferentially polymerizes into multilayer γ-graphyne flakes, as opposed to amorphous branched structures. As the polymerization appears to be self-templating, we assumed the existence of an attractive supramolecular interaction between TBTEB and the lattice of γ-graphyne. Self-assembly through solvophobically driven π-stacking has been documented for several phenylene ethynylene oligomers and macrocycles structurally related to graphynes. To explore the potential supramolecular interactions in our system, we computed by DFT the structure and potential energy surface for a single TBTEB molecule bound to a γ-graphyne monolayer. Our calculations predict that TBTEB would associate with the surface of graphyne at two types of binding sites (around the aromatic rings and over 12-DBA rings) with a binding energy in excess of 20 kcal/mol (FIG. 27). The monomer species outcompetes toluene, whose binding energy we estimate as ˜11 kcal/mol. If every TBTEB species were to react while bound over the underlying layer of γ-graphyne, one of the many local energy minimum stackings or a mixture of the stackings could result.

To our knowledge, our synthesis of γ-graphyne is the first example of an ordered covalent lattice formed spontaneously under purely kinetic control. Typical covalent organic frameworks and metal-organic frameworks are held together through bonds that are reversible. This reversibility is considered critical for continuous error correction during the reaction/crystallization process. Conventional thinking predicts that irreversible polymerization of an A₃B₃-type monomer, not employing a strict geometric constraint on reactivity, must yield only disordered branched structures. However, since we routinely observed micron-scale γ-graphyne crystallites, 2D polymerization assisted by crystallization must be presently kinetically favored over random 3D growth. Furthermore, the initial nucleation of flat graphyne sheets appears to be a highly probable event. The high fidelity of the resulting lattices indicates that the system is capable of correcting errors despite the irreversibility of Sonogashira coupling. At a minimum, the reaction must proceed comparably well at both lattice edges and internal defect sites. Since “patching” a single internal defect requires forming six new chemical bonds, it is highly likely that these bond-making steps are kinetically coupled. The apparent capability for error correction, as well as the strong dependence of the product structure on the nature of the Pd pre-catalyst, strongly corroborate our original hypothesis of a multi-site coupling mechanism.

From the above description of the invention, those skilled in the art will perceive improvements, changes, and modifications. Such improvements, changes, and modifications within the skill of the art are intended to be covered by the appended claims. All references, publications, and patents cited in the present application are herein incorporated by reference in their entirety.

1: A method comprising:
synthesizing covalently bonded lattices based on irreversible bond-making reactions which favor exhaustive substitution on multi-functional substrates.

2: The method of claim 1, wherein the bond-making reaction is a Sonogashira cross-coupling reaction between a terminal alkyne and an aryl halide.

3: The method of claim 2, wherein a reactant of the Sonogashira cross-coupling reaction is a 1,3,5-trihalo-2,4,6-triethynylbenzene monomer, either symmetric or unsymmetric, where the halogen is any of Cl, Br, or I or a ((2,4,6-trihalobenzene-1,3,5-triyl)tris(ethyne-2,1-diyl))tris(trimethylsilane) monomer, either symmetric or unsymmetric, where the halogen is any of Cl, Br, or I.

4. (canceled)

5: The method of claim 3, wherein the Sonogashira cross-coupling reaction is performed using a palladium catalyst, and wherein a type of palladium source of the catalyst is selected from palladium black, palladium on carbon, palladium(π-cinnamyl) chloride dimer, bis(triphenylphosphine)palladium(II) dichloride, bis(benzonitrile)palladium(II) chloride, bis(triphenylphosphine)palladium(II) diacetate, tetrakis(triphenylphosphine)palladium(0), bis(dibenzylideneacetone)palladium(0), tris(dibenzylideneacetone)dipalladium(0), dichlorobis(tricyclohexylphosphine)palladium(II), dichlorobis(tri-o-tolylphosphine)palladium(II), allylpalladium(II) chloride dimer, (2-methylallyl)palladium(II) chloride dimer, (1,3-bis(2,6-diisopropylphenyl)imidazolidene) (3-chloropyridyl) palladium(II) dichloride, (1,3-bis(2,6-dimethylphenyl)imidazolidene) (3-chloropyridyl) palladium(II) dichloride, [1,3-bis(2,6-diisopropylphenyl)imidazol-2-ylidene](3-chloropyridyl)palladium(II) dichloride, palladium(II) 2,4-pentanedionate, or any of the possible alkali metal salts of tris(3,3′,3″-phosphinidynetris(benzenesulfonato)palladium(0).

6: The method of claim 5, wherein the Sonogashira cross-coupling reaction is performed using a copper co-catalyst and wherein the copper co-catalyst is selected from copper(I) iodide, copper(I) chloride, copper(I) bromide, tetrakis(acetonitrile)copper(I) hexafluorophosphate, tetrakisacetonitrile copper(I) triflate, copper(0) foil or shavings combined with pyridine, copper(0) foil or shavings combined with any aliphatic tertiary amine, or copper(II) sulfate combined with sodium ascorbate.

7: The method of claim 6, wherein the reactant, palladium catalyst and copper co-catalyst are provided in a solvent and wherein the solvent is selected from pyridine, tetrahydrofuran, mixture of tetrahydrofuran and N,N-diisopropylethylamine, toluene, benzene, water, or biphasic mixtures of water and an immiscible organic solvent.

8: The method of claim 7, wherein loading of the Pd catalyst is between 0.5 mol % and 120 mol % relative to the 1,3,5-trihalo-2,4,6-triethynylbenzene monomer and/or loading of the Cu co-catalyst is between 0.1 mol % and 10 mol % relative to the 1,3,5-trihalo-2,4,6-triethynylbenzene monomer.

9. (canceled)

10: The method of claim 3, wherein the reaction temperature is between 60° C. and 130° C.

11: The method of claim 3, wherein the reaction is performed in the presence of a soluble fluoride salt.

12: The method of claim 1, wherein ordered two-dimensional polymerization occurs in the absence of a physical substrate or added template.

13: The method of claim 1, wherein the covalently bonded lattices include sp²/sp¹ allotropes of carbon.

14. (canceled)

15: The method of claim 1, wherein the covalent bonded lattices include γ-graphyne.

16: The method of claim 1, yielding multilayer γ-graphyne with linear size of crystalline domains in the range of 10 nanometers to 500 micrometers.

17: The method of claim 1, yielding 1 to 25 layers of γ-graphyne with linear size of crystalline flakes in the range of 10 nanometers to 500 micrometers.

18-33. (canceled)

34: Graphyne prepared by the process of claim 1.

35: The graphyne of claim 34, having a substantially perfect crystal uniformity and/or substantially perfect hexagonal crystal symmetry.

36: The graphyne of claim 35, having minimal or no crystalline defects.

37: The graphyne of claim 35, having a 1:1 ratio of sp¹ to sp² carbons in the crystalline material.

38: γ-Graphyne with linear size of crystalline domains in the range of 10 nanometers to 500 micrometers.

39: The γ-graphyne of claim 38, including multifunctional reactive groups on edges of the γ-graphyne.

40: The γ-graphyne of claim 38, wherein the multifunctional reactive groups are selected from alkyne and halo groups.
